(19) United States
(12) Patent Application Publication
(10) Pub. No.: US 2009/0018300 A1
(43) Pub. Date: Jan. 15, 2009

(54) MONOMERS AND POLYMERS FROM BIODERIVED CARBON

(75) Inventors: Paul D. Bloom, Decatur, IL (US); Padmesh Venkitasubramanian, Decatur, IL (US)

Correspondence Address: K&L GATES LLP;HENRY W. OLIVER BUILDING, 535 SMITHFIELD STREET, PITTSBURGH, PA, 15222, US

(73) Assignee: Archer-Daniels-Midland Company, Decatur, IL (US)

(21) Appl. No.: 12/169,248

(22) Filed: Jul. 8, 2008

Related U.S. Application Data
(60) Provisional application No. 60/949,091, filed on Jul. 11, 2007.

(51) Int. Cl. C08H 5/00

(52) U.S. Cl. 527/102

(57) ABSTRACT

The present disclosure provides compositions including biobased monomers derived from biological sources for the synthesis of polymers from bioderived carbon. The monomers and resulting polymers are comparable to petroleum derived monomers and polymers, but have a carbon isotope ratio characteristic of bioderived materials. Methods for synthesizing polymers having 100% biobased materials are also disclosed.

### CROSS REFERENCE TO RELATED APPLICATIONS

The application claims the priority benefit of U.S. Provisional Patent Application 60/949,091, filed Jul. 11, 2007, the disclosure of the entirety of which is incorporated by this reference.

### TECHNICAL FIELD

The present disclosure provides compositions comprising biobased monomers derived from biological sources for the synthesis of polymers from bioderived carbon. The monomers and resulting polymers may be comparable to petroleum derived monomers and polymers, but have a carbon isotope ratio characteristic of bioderived materials. Methods for synthesizing polymers having up to 100% biobased materials are also disclosed.

### BACKGROUND

Acrylate esters may be produced commercially from petrochemical sources. For example, in industry, acrylic acid is typically synthesized from acrolein through the catalytic oxidation of the petroleum derived propylene. Alternatively, acrylic acid may be industrially synthesized from petrochemically derived ethylene, carbon monoxide, and water. These processes are industrially feasible due to the relatively low price of the propylene and ethylene feedstock. Both propylene and ethylene are industrial by-products of gasoline manufacturing, for example, as by-products of fluid cracking of gas oils or steam cracking of hydrocarbons.

The world's supply of petroleum is being depleted at an increasing rate. Eventually, demand for petrochemical derived products may outstrip the supply of available petroleum. When this occurs, the market price of petroleum and, consequently, petroleum derived products will likely increase, making products derived from petroleum more expensive and less desirable. As the available supply of petroleum decreases, alternative sources and, in particular, renewable sources of comparable products will necessarily have to be developed.

In an effort to diminish dependence on petroleum products the United States government enacted the Farm Security and Rural Investment Act of 2002, section 9002 (7 U.S.C. §8102), hereinafter “FRISA”, which requires federal agencies to purchase biobased products for all items costing over $10,000. In response, the United States Department of Agriculture (“USDA”) has developed Guidelines for Designating Biobased Products for Federal Procurement (7 C.F.R. §2902) to implement FRISA, including the labeling of biobased products with a “U.S.D.A. Certified Biobased Product” label.

As used herein, the term “bioderived” means derived from or synthesized by a renewable biological feedstock, such as, for example, an agricultural, forestry, plant, bacterial, or animal feedstock. As used herein, the term “biobased” means a product that is composed, in whole or in significant part, of biological products or renewable agricultural materials (including plant, animal and marine materials) or forestry materials. As used herein, the term “petroleum derived” means a product derived from or synthesized from petroleum or a petrochemical feedstock.

FRISA has established certification requirements for determining biobased content. These methods require the measurement of variations in isotopic abundance between biobased products and petroleum derived products, for example, by liquid scintillation counting, accelerator mass spectrometry, or high precision isotope ratio mass spectrometry. Isotopic ratios of the isotopes of carbon, such as the ¹³C/¹²C carbon isotopic ratio or the ¹⁴C/¹²C carbon isotopic ratio, can be determined using isotope ratio mass spectrometry with a high degree of precision. Studies have shown that isotopic fractionation due to physiological processes, such as, for example, CO₂ transport within plants during photosynthesis, leads to specific isotopic ratios characteristic of natural or bioderived compounds. Petroleum and petroleum derived products have a different carbon isotopic ratio than bioderived products, for example, due to different chemical processes and isotopic fractionation during the generation of petroleum. In addition, radioactive decay of the unstable ¹⁴C carbon radioisotope leads to different isotope ratios in biobased products compared to petroleum products. Biobased content of a product may be verified by ASTM International Radioisotope Standard Method D 6866. ASTM International Radioisotope Standard Method D 6866 determines biobased content of a material based on the amount of biobased carbon in the material or product as a percent of the weight (mass) of the total organic carbon in the material or product. Both bioderived and biobased products will have carbon isotope ratios characteristic of a biologically derived composition, whereas petroleum derived products will have carbon isotope ratios characteristic of compositions derived from petrochemical sources.

The olefin metathesis reaction has become a powerful weapon for the coupling of carbon-carbon double bonds. Drs. Grubbs, Schrock, and Chauvin shared the 2005 Nobel Prize in Chemistry for the development of the olefin metathesis reaction. The generally accepted mechanism for the olefin metathesis reaction involves a metal carbene acting as a catalyst to metathesize two alkenes into a new alkene through a metallocyclobutane intermediate. The newly synthesized alkene contains one methylene carbon from each of the two starting alkenes. Olefin metathesis catalysts developed by Schrock, Grubbs, and others are commercially available, making the olefin metathesis reaction a viable and useful strategy in organic chemistry. Examples of commercially available olefin metathesis catalysts include the “Schrock catalyst” (i.e., [Mo(═CHMe₂Ph)(=N—Ar)(OCMe(CF₃)₂)₂], the “1st generation Grubb's catalyst” (i.e., [Ru(═CHPh)Cl₂(PCy₃)₂], and the “2nd generation Grubb's catalyst” (i.e, [Ru(═CHPh)Cl₂PCy₃(N,N′-diaryl-2-imidazolidinyl)] (Me=methyl, Ph=phenyl, Ar=aryl, and Cy=cyclohexyl).

Olefins, for example, acrylate esters, may be used for the synthesis of polymers, for example, by free radical chain polymerization or by ring-opening metathesis polymerization (“ROMP”) of cyclic olefins with diacrylates. For example, ring-opening metathesis polymerization of cyclic olefins with diacrylates for the synthesis of A,B-alternating co-polymers are generally described in U.S. Patent Application Publication Nos. 2003/0236367 and 2003/0236377; and Choi et al., in Angewandte Chemie, International Edition, 2002, 41, 3839-3841, the disclosures of which are incorporated by reference herein in their entirety. However in these references, since the diacrylate and cyclic olefin co-monomers are derived from petrochemical sources, the resulting polymers will have the isotopic ratios of petroleum derived products.

Biology offers an attractive alternative for industrial manufacturers looking to reduce or replace their reliance on petrochemicals and petroleum derived products. The replacement of petrochemicals and petroleum derived products or building blocks with products and/or feedstocks derived from biological sources (i.e., bioderived products) may offer many advantages. For example, products and feedstocks from biological sources are typically a renewable resource. As the supply of easily extracted petrochemicals continue to be depleted, the economics of petrochemical production will likely force the cost of the petrochemicals and petroleum derived products to higher prices. In addition, companies may benefit from the marketing advantages associated with bioderived products from renewable resources in the view of a public becoming more concerned with the supply of petrochemicals.

### SUMMARY

Certain embodiments of the present disclosure relate to polymer and monomer compositions that are 100% biobased as determined by ASTM International Radioisotope Method D 6866. Other embodiments relate to methods for producing polymers that are 100% biobased as determined by ASTM International Radioisotope Method D 6866.

An embodiment includes a polymer composition that is 100% biobased as determined by ASTM International Radioisotope Method D 6866. The polymer comprises a product from a metathesis polymerization reaction of a bioderived olefin and an acrylate ester of a bioderived alcohol. The acrylate ester is produced by reacting the bioderived alcohol with at least one equivalent of acrylic acid produced from bioderived glycerol.

Other embodiments include a polymer composition that is 100% biobased as determined by ASTM International Radioisotope Method D 6866. The polymer comprises a product of an acyclic diene metathesis polymerization reaction of a bioderived acyclic diene. The bioderived acyclic diene is made from a bioderived fatty acid.

Still other embodiments include a monomer composition for a polymerization reaction. The monomer comprises a diacrylate ester that is 100% biobased as determined by ASTM International Radioisotope Method D 6866. The diacrylate ester is produced by reacting a bioderived diol with at least two equivalents of acrylic acid produced from bioderived glycerol.

Further embodiments include methods for producing a bioderived polymer that is 100% biobased as determined by ASTM International Radioisotope Method D 6866. The method comprises reacting one of a bioderived diol, a bioderived amino alcohol, and a bioderived diamine with at least two equivalents of acrylic acid to yield a diacryl monomer product and reacting the diacryl monomer product with a bioderived olefin in a metathesis polymerization reaction to form the bioderived polymer. The acrylic acid is produced from bioderived glycerol.

Other embodiments include polymer compositions comprising a monomer unit having an electrophilic reactive group and a nucleophilic reactive group, wherein the nucleophilic reactive group reacts with the electrophilic reactive group via a Baylis-Hillman type reaction to form a polymer. Methods of forming a polymer comprising polymerizing a monomer unit via a Baylis-Hillman type reaction to form a polymer are also disclosed, wherein the monomer unit comprises an electrophilic reactive group and a nucleophilic reactive group. Suitable electrophilic groups may be selected from the group consisting of an aldehyde, an aldimine, an α,β-unsaturated carbonyl, and an α,β-unsaturated nitrile and the nucleophilic reactive group is selected from the group consisting of an α,β-unsaturated ester, α,β-unsaturated amide, α,β-unsaturated aldehyde, an α,β-unsaturated ketone, an α,β-unsaturated sulfone, an α,β-unsaturated sulfonate, α,β-unsaturated nitrile, and an α,β-unsaturated phosphate.

Still other embodiments include AB alternating condensation polymer compositions comprising a first monomer unit and a second monomer unit, wherein the first monomer unit reacts with the second monomer unit via a Baylis-Hillman type reaction to form a polymer. Methods of forming an AB alternating condensation polymer composition comprising polymerizing a first monomer unit and a second monomer unit via a Baylis-Hillman type reaction to form the AB alternating condensation polymer are also disclosed. The first monomer unit comprises a first electrophilic reactive group and a second electrophilic reactive group, wherein the first electrophilic reactive group and the second electrophilic reactive group are each independently selected from the group consisting of an aldehyde, an aldimine, an α,β-unsaturated carbonyl, and an α,β-unsaturated nitrile. The second monomer unit comprises a first nucleophilic reactive group and a second nucleophilic reactive group, wherein the first nucleophilic reactive group and the second nucleophilic reactive group are each independently selected from the group consisting of an α,β-unsaturated ester, an α,β-unsaturated amide, an α,β-unsaturated aldehyde, an α,β-unsaturated ketone, an α,β-unsaturated sulfone, an α,β-unsaturated sulfonate, an α,β-unsaturated nitrile, and an α,β-unsaturated phosphate.

In another embodiment, a method of forming a polymer is presented, the method comprising polymerizing a monomer unit via a Baylis-Hillman type reaction to form a polymer, wherein the monomer unit comprises an electrophilic reactive group and a nucleophilic reactive group, wherein the electrophilic reactive group is selected from the group consisting of an aldehyde, an aldimine, an α,β-unsaturated carbonyl, and an α,β-unsaturated nitrile and the nucleophilic reactive group is selected from the group consisting of an α,β-unsaturated ester, an α,β-unsaturated amide, an α,β-unsaturated aldehyde, an α,β-unsaturated ketone, an α,β-unsaturated sulfone, an α,β-unsaturated sulfonate, an α,β-unsaturated nitrile, and an α,β-unsaturated phosphate.

In another embodiment, a method of forming an AB alternating condensation polymer is presented, the method comprising polymerizing a first monomer unit and a second monomer unit via a Baylis-Hillman type reaction to form an AB alternating condensation polymer, wherein the first monomer unit comprises a first electrophilic reactive group and a second electrophilic reactive group, wherein the first electrophilic reactive group and the second electrophilic reactive group are each independently selected from the group consisting of an aldehyde, an aldimine, an α,β-unsaturated carbonyl, and an α,β-unsaturated nitrile; and the second monomer unit comprises a first nucleophilic reactive group and a second nucleophilic reactive group, wherein the first nucleophilic reactive group and the second nucleophilic reactive group are each independently selected from the group consisting of an α,β-unsaturated ester, an α,β-unsaturated amide, an α,β-unsaturated aldehyde, an α,β-unsaturated ketone, an α,β-unsaturated sulfone, an α,β-unsaturated sulfonate, an α,β-unsaturated nitrile, and an α,β-unsaturated phosphate.

### BRIEF DESCRIPTION OF DRAWINGS

The various embodiments of the present disclosure will be better understood when read in conjunction with the following figures.

FIG. 1 illustrates one non-limiting strategy for the conversion of glycerol to industrial useful chemical feedstocks.

FIGS. 2A, 2B, and 3 illustrate non-limiting strategies for synthesizing biobased diols from saturated or unsaturated fatty acids.

FIGS. 4 and 5 illustrate NMR spectra of butoxymethylfurfuryl acrylate product.

FIGS. 6 and 7 illustrate NMR spectra of 5-hydroxymethylfurfuryl acrylate product.

FIGS. 8 and 9 illustrate NMR spectra of 5-hydroxymethylfurfuryl acrylate ester product.

FIGS. 10 and 11 illustrate NMR spectra of isosorbide diacrylate product.

FIGS. 12 and 13 illustrate NMR spectra of triallyl citrate product.

FIG. 14. illustrates the NMR spectrum of epoxidized triallyl citrate.

FIGS. 15 and 16 illustrate NMR spectra of 5-butoxymethylfurfuryl acrylate (Baylis-Hillman adduct).

FIGS. 17 and 18 illustrate NMR spectra of 5-hydroxymethylfurfuryl acrylate (Baylis-Hillman adduct).

FIG. 19 illustrates an NMR spectrum of a polymer formed from HMF acrylate.

FIG. 20 illustrates a gel permeation chromatogram of a polymer formed from HMF acrylate.

### DETAILED DESCRIPTION

Various embodiments of the present disclosure relate to a biobased monomer units derived from glycerol. In particular, glycerol from biological sources may be converted to acrylic acid and corresponding acrylate derivatives, such as, for example, diacrylate esters, by condensation with a bioderived diol. The resulting diacrylate monomers may be used in the synthesis of polymers having up to a 100% biobased carbon isotope ratio, for example, via olefin metathesis polymerization reactions or free radical polymerization reactions. The resulting polymers may be differentiated from polymers derived from petroleum feedstocks, for example by the carbon isotopic ratio using ASTM International Radioisotope Standard Method D 6866 (“ASTM Method D 6866”). As used herein, the term “100% biobased carbon isotope ratio” means a composition or component of a composition having a carbon isotope ratio that is indicative of a composition that is produced by a biological source (i.e., bioderived), such as, for example, a botanical or plant source. As used herein, the term “bioderived” means derived from or synthesized by a renewable biological feedstock, such as, for example, an agricultural, forestry, plant, bacterial, or animal feedstock. As used herein, the term “biobased” means a product that is composed, in whole or in significant part, of biological products or renewable agricultural materials (including plant, algal, animal and marine materials) or forestry materials. As used herein, the term “petroleum derived” means a product derived from or synthesized from petroleum or a petrochemical feedstock.

As used in this specification and the appended claims, the articles “a”, “an”, and “the” include plural referents unless expressly and unequivocally limited to one referent.

Other than in the operating examples, or where otherwise indicated, all numbers expressing quantities of ingredients, reaction conditions and the like used in the specification and claims are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

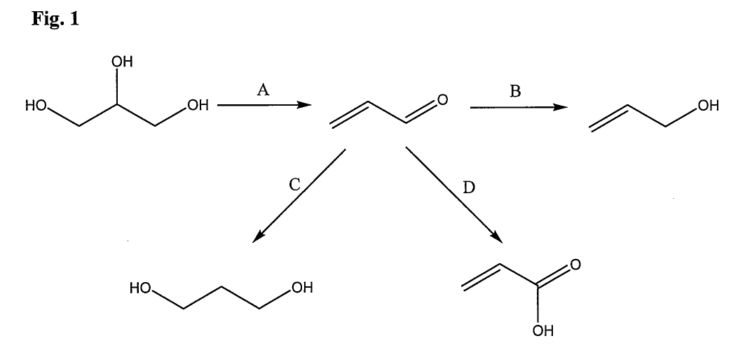

Acrylic acid having a 100% biobased carbon isotope ratio may be produced from bioderived glycerol, lactic acid, and/or lactate esters. For example, FIG. 1 illustrates one non-limiting strategy for the conversion of bioderived glycerol to industrial useful chemical feedstocks, such as, acrylic acid (2-propenoic acid), allyl alcohol (2-propen-1-ol), and 1,3-propanediol, having a 100% biobased carbon isotope ratio. Referring now to FIG. 1, bioderived glycerol may be dehydrated (reaction A) to give acrolein (2-propenal). The acrolein may be oxidized to afford acrylic acid (2-propenoic acid) via pathway D. Alternatively, acrolein may be reduced to give allyl alcohol (2-propen-1-ol) via pathway B. Suitable methods for the conversion of acrolein to allyl alcohol include, but are not limited to, reactions catalyzed by a silver indium catalyst as described by Lucas et al. in Chemie Ingenieur Technik, 2005, 77, 110-113, the disclosure of which is incorporated by reference herein in its entirety. Further, acrolein may be converted to 1,3-propanediol by pathway C. One suitable method for the conversion of acrolein to 1,3-propanediol includes hydration followed by hydrogenation as described in U.S. Pat. No. 5,171,898, the disclosure of which is incorporated by reference herein in its entirety. The industrial/chemical feedstocks produced from glycerol, via acrolein, as set forth herein, will have a carbon isotope ratio that can be identified as being derived from biomass (i.e., biobased).

Alternatively, biobased acrylic acid or acrylate esters may be synthesized from biobased lactic acid or lactate esters. Biobased lactic acid derivatives may be bio-synthesized, for example, by fermentation of a carbohydrate material. Conversion of lactic acid and lactate esters into acrylic acid and acrylate esters, respectively, may be accomplished by dehydration of the alcohol group of the lactate moiety. Suitable methods for the conversion of lactic acid and lactate esters, for example, lactic acid/lactate esters from the fermentation of carbohydrate material in the presence of ammonia, into an acrylate ester or acrylic acid are disclosed in U.S. Pat. Nos. 5,071,754 and 5,252,473, the disclosures of which are incorporated by reference herein in their entirety.

As discussed herein, the present disclosure relates to biobased monomers that may be used for the synthesis of polymers having up to a 100% biobased carbon isotope ratio. According to certain embodiments, the present disclosure provides for biobased monomers that may be used for the synthesis of polymers having from 1% to 99.9% biobased carbon. According to other embodiments, the present disclosure provides for biobased monomers that may be used for the synthesis of polymers having from 50% to 99.9% biobased carbon. Thus, the glycerol and carbohydrate starting materials described herein will necessarily be derived from biological sources. For example, bioderived glycerol containing 100% biobased carbon, as determined by ASTM Method D 6866, may be derived from triglycerides (triacylglycerols) from biological sources, for example, a vegetable oil or an animal fat, by splitting the triglyceride into the corresponding fatty acids and glycerol. Triglycerides may be converted into the corresponding fatty acids and glycerol by acidic hydrolysis, basic hydrolysis (saponification) or by a catalytic de-esterification. Suitable triglycerides for use in the formation of bioderived glycerol include, but are not limited to, corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, tallow, beef tallow, butter, chicken fat, lard, dairy butterfat, shea butter, biodiesel, used frying oil, oil miscella, used cooking oil, yellow trap grease, hydrogenated oils, derivatives of these oils, fractions of these oils, conjugated derivatives of these oils, and mixtures of any thereof.

Suitable bioderived olefins include, but are not limited to monoacrylates, diacrylates, and allyl esters.

Alternatively, bioderived glycerol may be produced as a co-product of biodiesel production. Glycerol produced by these methods will have a carbon isotope ratio consistent with a 100% biobased product and will provide a renewable source of acrolein and acrylic acid that may be used as a feedstock for the biobased monomers and polymers of the present disclosure. Non-limiting examples of methods and processes for producing biodiesel may be found in U.S. Pat. No. 5,354,878; U.S. Patent Application Publication Nos. 20050245405A1; 2007-0181504; and 20070158270A1; Provisional Patent Application Ser. No. 60/851,575, the disclosures of which are incorporated in their entirety by reference herein.

The monomers and polymers, as set forth herein, may have up to 100% biobased carbon isotope ratio as determined by ASTM Method D 6866. The monomers and polymers may be differentiated from, for example, similar monomers and polymers comprising petroleum derived components by comparison of the carbon isotope ratios, for example, the ¹⁴C/¹²C or the ¹³C/¹²C carbon isotope ratios, of the materials. As described herein, isotopic ratios may be determined, for example, by liquid scintillation counting, accelerator mass spectrometry, or high precision isotopic ratio mass spectrometry.

Biobased acrylic acid (or acrylate esters), for example acrylic acid and esters synthesized by any of the embodiments described herein, may be esterified (or transesterified) with other bioderived alcohols, diols, or polyols. Non-limiting suitable bioderived alcohols and diols include, for example, methanol; ethanol; n-butanol, for example from an acetone/butanol fermentation; fusel oil alcohols (n-propanol, isobutyl alcohol, isoamyl alcohol, and/or furfural); and alcohol and diol derivatives derived from carbohydrates or their derivatives.

Non-limiting examples of carbohydrate derived diols include hydroxymethylfurfuryl, 2,5-bis(hydroxymethyl)furan, 2,5-bis(hydroxymethyl)tetrahydrofuran, and isosorbide (dianhydrohexitol), isomannide, mannitol, xylitol, maltitol, maltitol syrup, lactitol, erythritol, isomalt, isoidide (the dianhydrohexitol of iditol), structure A, or ethoxylated or propoxylated derivatives of these,

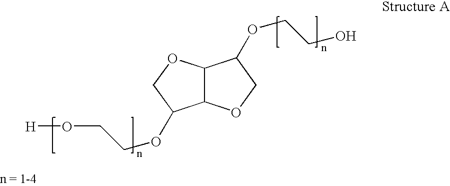

Non-limiting representative structures of diacrylate esters of certain carbohydrate derived alcohols are presented in Scheme I. The diacrylate esters produced from carbohydrate derived diols may act as monomers or co-monomers having 100% biobased carbons, as determined by ASTM Method D 6866, for the synthesis of polymers having up to 100% biobased carbon.

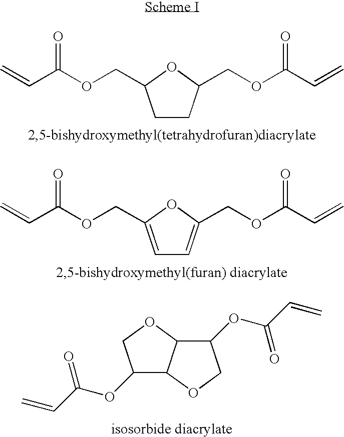

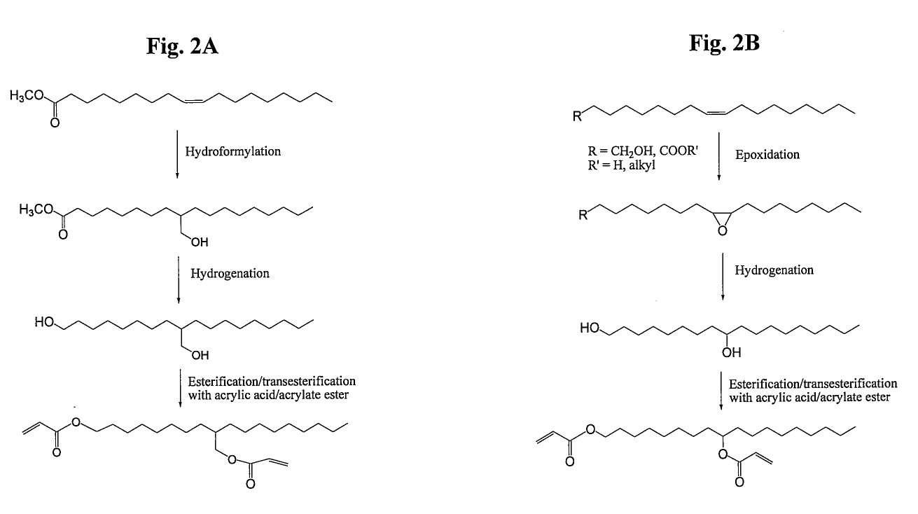

Other embodiments of biobased diols suitable for producing diacrylate esters having 100% biobased carbon may be produced from fatty acids, such as, for example, unsaturated fatty acids. For example, hydroformylation of unsaturated fatty acids and their derivatives to produce fatty acid derivatives having a hydroxymethylene group is described in U.S. Pat. No. 3,210,325 to De Witt et al., the disclosure of which is incorporated in its entirety by reference herein. Reduction of the carbonyl of the fatty acid derivative, for example, by hydrogenation, produces a biobased diol suitable for esterification or transesterification with acrylic acid or an acrylate ester, as produced herein, to form a biobased diacrylate monomer. One non-limiting embodiment of this approach is illustrated in FIG. 2A.

According to another embodiment, biobased diols suitable for producing diacrylate esters having 100% biobased carbon may be produced by epoxidation of at least one of the double bonds of an unsaturated fatty acid/ester or unsaturated fatty alcohol. One non-limiting example of the epoxidation procedure is described by Rao et al., Journal of the American Oil Chemists' Society, (1968), 45(5), 408, the disclosure of which is incorporated in its entirety by reference herein. The epoxidation may be followed by reduction, for example, by hydrogenation, to open the epoxide to the alcohol, which may also include reduction of the carbonyl of the fatty acid/ester to the alcohol. Any biobased diol may then be esterified or transesterified with acrylic acid or an acrylate ester, as produced herein, to form a diacrylate monomer having 100% biobased carbon. One non-limiting embodiment of this approach is illustrated in FIG. 2B.

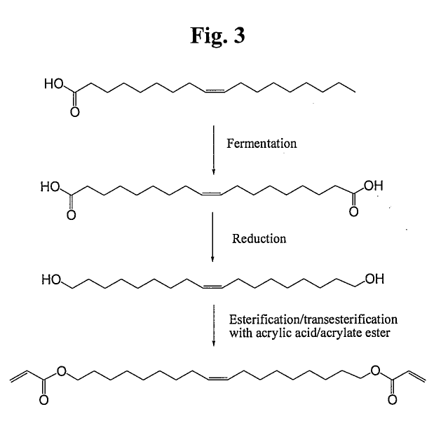

According to still another embodiment, diols suitable for producing diacrylate esters having 100% biobased carbon may be produced by reduction of α,ω-dicarboxylic acids. As used herein, the term α,ω-dicarboxylic acid” includes organic molecules comprising a carbon chain of at least 1 carbon atom and two carboxylic acid functional groups, each of which is positioned at opposite ends of the carbon chain. For example, α,ω-dicarboxylic acids may be produced by a fermentation process involving biobased fatty acids, such as, by a fermentation process as described in Craft, et al., Applied and Environmental Microbiology, (2003), 69(10), 5983-5991 and/or U.S. Pat. No. 6,569,670 to Anderson et al., the disclosures of which are incorporated in their entirety by reference herein. Other α,ω-dicarboxylic acids from biobased sources, such as, for example, maleic acid, fumaric acid, oxalic acid, malonic acid, adipic acid, succinic acid, and glutaric acid, adipic acid, pimelic acid, suberic acid, azelaic acid, and sebacic acid may also be used according to various embodiments of the present disclosure. According to certain embodiments, the α,ω-dicarboxylic acid may be an unsaturated α,ω-dicarboxylic acid or a saturated α,ω-dicarboxylic acid. Reduction of the carbonyls of the α,ω-dicarboxylic acids provides a biobased diol which may then be esterified or transesterified with acrylic acid or an acrylate ester, as produced herein, to form a biobased diacrylate monomer. One non-limiting embodiment of this approach is illustrated in FIG. 3.

According to other embodiments, bioderived diacrylamide derivatives may serve as monomers for the polymerization reactions described herein. For example, according to certain embodiments, the diol component in the formation of the diacrylate esters described herein, may be chemically converted to a biobased diamine, for example, by a double Mitsunobu-type reaction. Non-limiting examples of resulting biobased diamines may include, for example, bis-amino isosorbide, 2,5-bisaminomethyltetrahydrofuran, 2,5-bisaminomethylfuran. Alternatively, naturally occurring bioderived diamines, such as, for example, 1,4-diaminobutane, 1,5-diaminopentane, or other alkyldiamines or diamine containing alkaloid derivatives, may be replace the diol reactant in the reaction with the bioderived acrylate derivative to form a diacryl amide compound. Further, it is also contemplated that bioderived amino alcohols may replace the diol component in the formation of the biobased monomers. According to these embodiments, the bioderived amino alcohols may be reacted with the bioderived acrylic acid or bioderived acrylate esters to form a bioderived monomer possessing both an acrylate ester and an acrylamide functionality. Non-limiting examples of several potential biobased diacrylamides or monomers derived from amino alcohols that may be suitable for use in various embodiments of the present disclosure are illustrated in Scheme II and Scheme III.

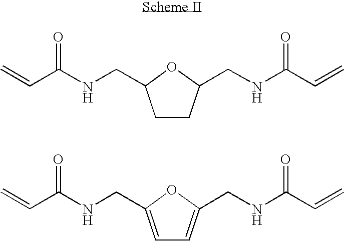

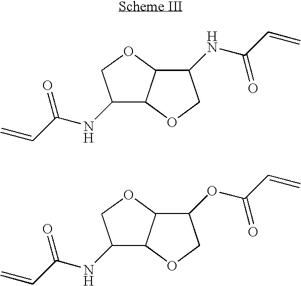

Bioderived diacryl derivatives, such as the diacrylate esters, diacrylamides, and acrylate/acrylamide monomers, according to various embodiments of the present disclosure, may serve as monomers or co-monomers in a polymerization reaction to produce a biobased polymer. For example, according to certain embodiments, an olefin metathesis polymerization reaction may be used to produce the biobased polymer. As used herein, the term “metathesis polymerization” includes an olefin metathesis reaction involving a metal carbene acting as a catalyst to metathesize alkene monomers or co-monomers into a polyunsaturated polymer through a metallocyclobutane intermediate. Thus, certain embodiments of the present disclosure provide for a polymer comprising a product from an olefin metathesis polymerization reaction of a bioderived olefin and a diacrylate ester of a bioderived diol, wherein the diacrylate ester is produced by reacting a bioderived diol with at least two equivalents of acrylic acid or an acrylate ester derived from a bioderived glycerol. The olefin metathesis polymerization reaction may be catalyzed by an olefin metathesis catalyst, such as a metal carbene catalyst, for example, metal carbenes of molybdenum or ruthenium. Commercially available olefin metathesis catalysts suitable for use in the polymerization reactions of the present disclosure include, but are not limited to, the “Schrock catalyst” (i.e., [Mo(═CHMe₂Ph)(=N—Ar)(OCMe(CF₃)₂)₂]), the “1st generation Grubb's catalyst” (i.e., [Ru(═CHPh)Cl₂(PCy₃)₂]), and the “2nd generation Grubb's catalyst” (i.e, [Ru(═CHPh)Cl₂PCy₃(N,N′-diaryl-2-imidazolidinyl)]) (Me=methyl, Ph=phenyl, Ar=aryl, and Cy=cyclohexyl). Other olefin metathesis catalysts that may be suitable for use in various embodiments of the present disclosure include those catalysts set forth in U.S. Pat. 7,034,096 to Choi et al. at column 12, line 27 to column 19, line 2, the disclosure of which is incorporated in its entirety by reference herein. It should be noted that the polymers and polymerization process claimed in the present disclosure are not limited to a particular olefin metathesis catalyst(s) and that any olefin metathesis catalyst, either currently available or designed in the future, may be suitable for use in various embodiments of the present disclosure.

According to certain embodiments, the bioderived olefin component of the metathesis polymerization may be a bioderived cyclic olefin, wherein the metathesis polymerization reaction is a ring opening metathesis polymerization (“ROMP”) reaction. As used herein, the term “ring opening metathesis polymerization reaction” includes olefin metathesis polymerization reactions wherein at least one of the monomer alkene units comprises a cyclic olefin. Thus, the ROMP reaction may react a bioderived diacryl derivative with a bioderived cyclic olefin to produce a polymer that is up to 100% biobased as determined by ASTM Method D 6866. Bioderived cyclic olefins may be prepared, for example, from palmitoleic acid, oleic acid, erucic acid, linoleic acid, linolenic acid, arachidonic acid, eicosapentaenoic acid, docosahexaenoic acid, and other unsaturated fatty acids.

According to certain embodiments of the polymer comprising a product from a ROMP reaction of a bioderived cyclic olefin and a diacryl derivative, as described herein, the polymer may be an A,B-alternating polymer (also called an AB alternating condensation polymer or -(AB)ₙ—). As used herein, the terms “A,B-alternating polymer” or “AB alternating condensation polymer” include regioregular polymers having a polymeric backbone wherein the co-polymer is composed of the two monomeric units (i.e., monomeric unit A and monomeric unit B) connected in a regularly alternating arrangement (i.e., . . . ABABABAB . . . ) along the backbone. Examples of ROMP procedures suitable for use in various embodiments of the present disclosure are set forth, for example, in Choi et al., Angewandte Chemie, International Edition, (2002), 41(20), 3839-3841, and U.S. Pat. Nos. 6,987,154 and 7,034,096 to Choi et al., the disclosures of which are incorporated in their entirety by reference herein.

The bioderived cyclic olefin may be, for example, the product from an anodic coupling of a bioderived monounsaturated long chain α,ω-dicarboxylic acid. For example, bioderived monounsaturated long chain α,ω-dicarboxylic acids, which may be synthesized as described herein, may be cyclized to a cyclic olefin via an intramolecular cyclic anodic coupling process. For example, one non-limiting method for synthesizing cyclic olefins from dicarbonyl compounds using TiCl₃ with a Zn—Cu couple is described in McMurry et al., Journal of Organic Chemistry, (1977), 42(15), 2655-2656, the disclosure of which is incorporated in its entirety by reference herein. Cyclic olefins having a ring size containing 4-20 ring carbons may be synthesized using this approach. According to other embodiments, bioderived cyclic olefins having from 10-20 ring carbons may be synthesized by anodic coupling of monounsaturated long chain α,ω-dicarboxylic acids derived from biobased fatty acids. According to still other embodiments, the bioderived cyclic olefin may be derived from oleic acid and have 18 ring carbons (cyclooctadecene). According to other embodiments, the bioderived cyclic olefins having from 10-20 ring carbons may be synthesized by anodic coupling of monounsaturated long chain α,ω-dicarboxylic acids derived from biobased unsaturated fatty acids including palmitoleic acid, oleic acid, erucic acid, linoleic acid, linolenic acid, arachidonic acid, eicosapentaenoic acid, docosahexaenoic acid, and other unsaturated fatty acids.

According to other embodiments, certain bioderived olefin components of the metathesis polymerization may be a bioderived acyclic diene, wherein the metathesis polymerization reaction is an acyclic diene metathesis (“ADMET”) polymerization reaction. As used herein, the term “acyclic diene metathesis polymerization reaction” includes a reaction between a diacrylate ester of a bioderived diol with at least one bioderived acyclic diene. Bioderived acyclic dienes suitable for use in ADMET polymerization reactions according to various embodiments herein may be synthesized, for example, from bioderived fatty acids. For example, bioderived dienes may be synthesized from α,ω-dicarboxylic acids (or their ester or amide derivatives, which may be synthesized, for example, from fatty acids as described herein) by reduction of both carbonyl functionalities to hydroxyl groups followed by a bis-dehydration of both hydroxyl groups to form the terminal diene. One non-limiting example of a reduction/dehydration strategy for forming bioderived dienes is represented in Scheme IV.

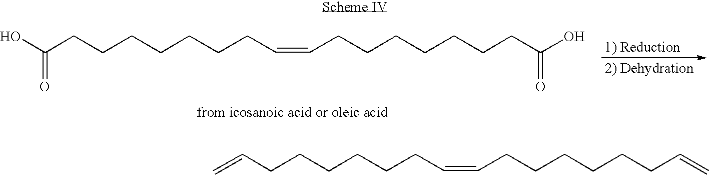

The resulting bioderived diene may be used as a co-monomer with at least one diacrylate ester of a bioderived diol co-monomer in an ADMET polymerization reaction, for example, to form an AB-alternating polymer. Alternatively, the bioderived diene may be used directly as a monomer in an ADMET reaction as represented in Scheme V.

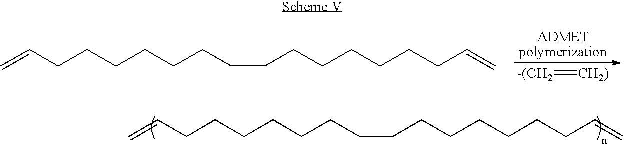

Alternatively, according to other embodiments, bioderived acyclic dienes suitable for use in ADMET type polymerization reactions, either as a monomer or a co-monomer, may be synthesized from biobased unsaturated fatty acids via an anodic coupling process. For example, according to one embodiment, an unsaturated fatty acid, such as, but not limited to, oleic acid, may be anodically coupled to yield a C₃₄ internal alkyldiene having a 100% biobased carbon content, as represented in Scheme VI. The alkyldienes produced by this process may be used as monomers or co-monomers in ADMET polymerization reactions, such as those reactions described herein, to form 100% biobased polymers.

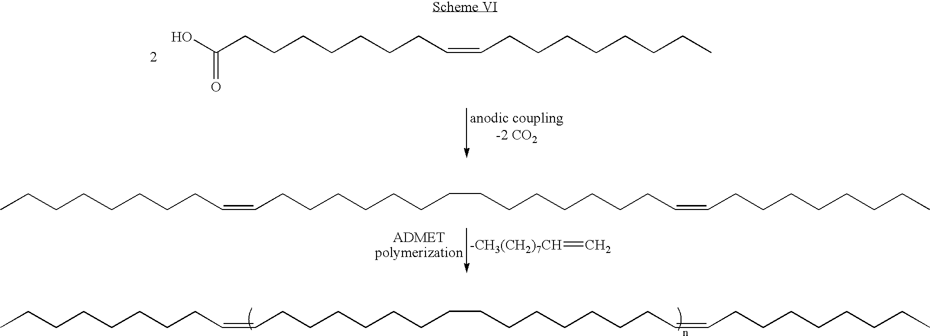

Other embodiments of the present disclosure provide for a biobased polymer comprising a product of an ADMET polymerization reaction of a bioderived acyclic diene, wherein the bioderived acyclic diene is made from a bioderived fatty acid and the polymer is 100% biobased as determined by ASTM international Radioisotope Method D 6866. Scheme VI illustrates one non-limiting approach for using a biobased alkyldiene as a monomer in an ADMET polymerization reaction to produce a biobased polymer product. According to certain embodiments where the biobased alkyldiene is used directly as a monomer in an ADMET polymerization, the product of the polymerization reaction may be a polymer having an average molecular weight in the range of 3,000 g/mol to 60,000 g/mol. For example, according to one non-limiting embodiment, the polymer product of the coupling product of oleic acid may have an average molecular weight of approximately 40,000 g/mol. Further according to other embodiments, the ADMET polymerization products from the direct polymerization of biobased alkyldiene monomers may have a polydispersity index (“PDI”) within the range of 1 to 3. As used herein, the polydispersity index is a measure of the distribution of molecular weights in a given polymer sample. The PDI may be calculated as the weight average molecular weight divided by the number average molecular weight.

The ADMET polymerization products of biobased alkyldiene monomers may be useful, for example, by further functionalization to synthesize intermediates, plasticizers, coatings, polyurethanes, foams, and the like. For example according to certain embodiments, ADMET polymerization products of biobased alkyldiene monomers may be further functionalized by hydroformylation, hydroxylation (including both monohydroxylation and dihydroxylation of at least one of the alkene moieties), epoxidation, hydrogenation, or other reactions of the alkene functionality. Hydroformylation may be carried out according to the procedures described in U.S. Pat. No. 3,210,325 to De Witt et al. Hydroxylation may be carried out as described by Frank D. Gunstone in “10. Chemical Properties; 10.4.2 Hydroxylation”, in The Lipid Handbook, Second Edition (Frank D. Gunstone, John L. Harwood & Fred D. Padley, eds.), Chapman & Hall, London, 1994 and references therein. Epoxidation may be carried out as described by Frank D. Gunstone in “10. Chemical Properties; 10.4.1 Epoxidation”, in The Lipid Handbook, Second Edition (Frank D. Gunstone, John L. Harwood & Fred D. Padley, eds.), Chapman & Hall, London, 1994 and references therein. Heat-bodying (polymerization) may be carried out as described by Fred L. Fox in “Unit Three: Oils for Organic Coatings”, in Federation Series on Coatings Technology (Wayne R. Fuller, Ed.), Federation of Societies for Paint Technology (Philadelphia) 1965 and references therein. Hydrogenation may be carried out as described by Frank D. Gunstone in “10. Chemical Properties; 10.1.1 Catalytic Hydrogenation”, in The Lipid Handbook, Second Edition (Frank D. Gunstone, John L. Harwood & Fred D. Padley, eds.), Chapman & Hall, London, 1994 and references therein. The disclosures of each of these references are hereby incorporated in their entirety by reference herein.

Other non-limiting embodiments of reactions and/or further functionalizations of long chain polyunsaturated hydrocarbons are set forth in greater detail in U.S. Patent Application Publication No. 20060149085A1, the disclosure of which is specifically incorporated in its entirety by reference herein. According to still other embodiments, the ADMET polymerization products of biobased alkyldiene monomers may be further functionalized by heat bodied polymerization, for example, as described in U.S. Patent Application Publication Nos. 20040030056A1 and 20070151480A1, the disclosures of which are specifically incorporated in their entirety by reference herein.

According to other embodiments, the present disclosure provides for methods of producing a bioderived polymer, such as, the bioderived polymers disclosed herein. According to one embodiment, the method may comprise reacting a reactant comprising a bioderived diol, a bioderived amino alcohol, or a bioderived diamine, wherein the compounds may be synthesized as described herein, with at least two equivalents of acrylic acid or an acrylate derivative (such as, an ester, anhydride, acyl halide, or amide) to yield a diacryl product and reacting the diacryl product with a bioderived olefin in a metathesis polymerization reaction to form the bioderived polymer, wherein the bioderived polymer is 100% biobased as determined by ASTM Method D 6866. According to various embodiments, the acrylic acid or acrylate derivative may be produced by a bioderived glycerol. According to other embodiments, the bioderived olefin may be any of the bioderived olefins disclosed herein, such as, for example, a bioderived cyclic olefin, a bioderived acyclic diene, or combinations thereof.

According to certain embodiments of the methods, the bioderived diol may be selected from the group consisting of 2,5-bis(hydroxymethyl)tetrahydrofuran, 2,5-bis(hydroxymethyl)furan, hydroxymethylfurfural, isosorbide (dianhydrohexitol), isomannide, mannitol, xylitol, maltitol, maltitol syrup, lactitol, erythritol, isomalt, isoidide, structure A, ethoxylated or propoxylated derivatives of these, a diol produced from the hydrogenation of a hydroformylated fatty acid, a diol produced from the hydrogenation of an epoxidized fatty acid ester, a diol produced from the reduction of an α,ω-dicarboxylic acid, and mixtures of any thereof. According to other embodiments of the methods, the bioderived diamine may be selected from the group consisting of bis-amino isosorbide, 2,5-bisaminomethyltetrahydrofuran, 2,5-bisaminomethylfuran, and mixtures of any thereof. Non-limiting examples of the bioderived diols, bioderived diamines, and methods of synthesis thereof are disclosed herein.

According to various embodiments of the methods, the bioderived olefin may be a cyclic olefin and the metathesis polymerization reaction may be a ROMP reaction. According to certain embodiments, the resulting bioderived polymer may be a bioderived A,B-alternating polymer. According to certain embodiments, the bioderived cyclic olefin may be produced, for example, from the anodic coupling of a monounsaturated α,ω-dicarboxylic acid derived from a bioderived fatty acid. According to still other embodiments of the methods, the bioderived olefin may be an acyclic diene derived from a bioderived fatty acid, as described herein. According to certain embodiments, wherein the bioderived olefin is an acyclic diene, the metathesis polymerization reaction may be an ADMET polymerization reaction.

According to various embodiments of the methods herein, the bioderived glycerol may be produced from a triacylglycerols (triglyceride) from biological sources, for example, a vegetable oil or an animal fat, by splitting the triglyceride into the corresponding fatty acids and glycerol. Triglycerides may be converted into the corresponding fatty acids and glycerol by heat and/or pressure, acidic hydrolysis, basic hydrolysis (saponification), or by a catalytic de-esterification. Suitable triglycerides for use in the formation of bioderived glycerol include, but are not limited to, corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, tallow, beef tallow, butter, chicken fat, lard, dairy butterfat, shea butter, biodiesel, used frying oil, oil miscella, used cooking oil, yellow trap grease, hydrogenated oils, derivatives of these oils, fractions of these oils, conjugated derivatives of these oils, and mixtures of any thereof. According to various embodiments of the methods herein, the bioderived glycerol may be produced from diacylglycerols (diglycerides) and/or monoacylglycerols (monoglycerides).

According to other embodiments, the present disclosure provides for a monomer for a polymerization reaction. The monomer may comprise a diacrylate ester that is 100% biobased as determined by ASTM Method D 6866, wherein the diacrylate ester is produced by reacting a bioderived diol with at least two equivalents of acrylic acid produced from bioderived glycerol or an acrylate derivative produced from bioderived glycerol. Various non-limiting methods of producing the monomer for the polymerization reaction are described herein. According to certain embodiments, the bioderived diol may be selected from the group consisting of 2,5-bis(hydroxymethyl)tetrahydrofuran, 2,5-bis(hydroxymethyl)furan, hydroxymethylfurfuryl, isosorbide (dianhydrohexitol), isomannide, mannitol, xylitol, maltitol, maltitol syrup, lactitol, erythritol, isomalt, isoidide, structure A, ethoxlated or propoxylated derivatives of these, a diol produced from the hydrogenation of a hydroformylated fatty acid, a diol produced from the hydrogenation of an epoxidized fatty acid ester, a diol produced from the reduction of an α,ω-dicarboxylic acid, and mixtures of any thereof. According to other embodiments, the monomer may comprise a diacryl amide as described herein.

As described herein, the biobased glycerol may be converted to alcohol derivatives, such as, for example, allyl alcohol (2-propen-1-ol, see FIG. 1, reactions A and B). Various embodiments of further biobased materials that may be derived from biobased glycerol and its derivatives, such as, allyl alcohol, may include reaction products of allyl alcohol with bioderived carboxylic acids and/or esters. For example, according to certain embodiments, citric acid is a bioderived tri-carboxylic acid. The carboxylic acid moieties of citric acid or other biobased carboxylic acids may be esterified with glycerol to form allyl esters. One example of this process is illustrated in Scheme VII. The allyl ester products may be used as industrial chemicals having 100% biobased content, as determined by ASTM Method D 6866. According to certain embodiments, the allyl esters may be incorporated into a variety of applications, such as, for example, alkyd coatings as reactive diluents to help reduce emissions of volatile organic compounds. Alternatively, the double bond(s) of the allyl esters, such as the allyl citrate esters, may be further derivatized, such as, for example, by epoxidation or derivatization of the free hydroxyl group (as shown in Scheme VII). Other biobased carboxylic acids and poly-carboxylic acids may be derivatized in a similar manner. For example the biobased α,ω-dicarboxylic acids may be converted to the bis-allyl ester product. It is further contemplated that the double bonds of the allyl esters may react as monomers or co-monomers in olefin metathesis polymerization reactions, such as the ROMP and/or ADMET polymerization reactions disclosed herein.

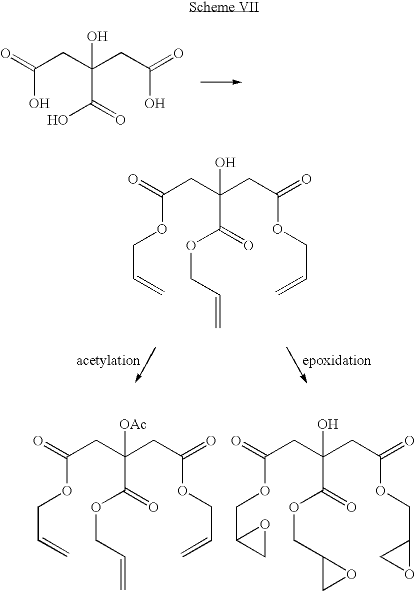

According to other embodiments, Baylis-Hillman type adducts may be formed between a bioderived electrophilic reactive group and a bioderived compound having an α,β-unsaturated electron-withdrawing group such as acrylic acid, and catalyzed by a tertiary amine, such as, for example, 1,4-diazabicyclo[2.2.2]octane (DABCO) to give polymers, for example, as described in Baylis, A. B.; Hillman, M. E. D. German Patent 2155113 (1972), the disclosure of which is incorporated in its entirety by reference herein. Alternatively, bioderived adducts may be formed between a bioderived electrophilic group and a bioderived compound having an α,β-unsaturated electron-withdrawing group such as acrylic acid, and catalyzed by an organophosphine, such as described by Rauhut and Currier in U.S. Pat. No. 3,074,999, the disclosure of which is incorporated in its entirety by reference herein.

For example, according to one embodiment, a polymer may be formed from at least one bioderived monomer unit wherein the polymer composition comprises a monomer unit having an electrophilic reactive group and a nucleophilic reactive group, wherein the nucleophilic reactive group reacts with a electrophilic reactive group via a Baylis-Hillman type reaction to form the polymer. As used herein, the term “Baylis-Hillman type reaction” includes reactions such as the “Bayliss-Hillman reaction” and the “Rauhut-Currier reaction”. While not intending to be limited by any particular mechanism, such reactions may characterized by activation of an α,β-unsaturated moiety by a Michael-type addition of a nucleophile, such as a tertiary amine or an organophosphine, to form an enolate which may then react with an electrophilic reactive group (such as a carbonyl or β-carbon of an α,β-unsaturated carbonyl) to form a carbon-carbon bond, followed by elimination of the nucleophile. One example of such a mechanism is presented in Mechanism A.

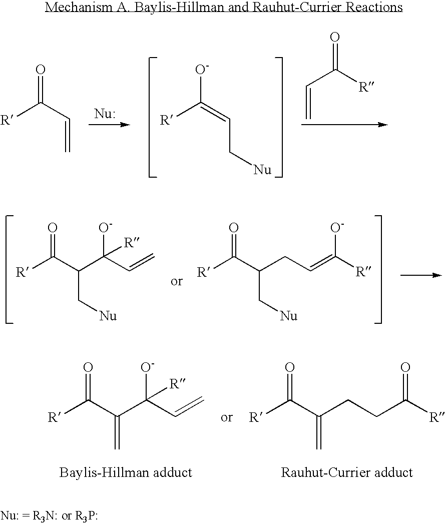

As used herein, the term “electrophilic reactive group” includes a functional group that accepts electrons or electron density during a bond forming process. As used herein, the term “nucleophilic reactive group” includes a functional group that donates electrons or electron density during a bond forming process. Suitable electrophilic reactive groups include, for example, an aldehyde, an aldimine, an α,β-unsaturated nitrile, or an α,β-unsaturated carbonyl containing compound, such as, an α,β-unsaturated aldehyde, and α,β-unsaturated ketone, an α,β-unsaturated ester, or an α,β-unsaturated amide. Suitable nucleophilic reactive groups include, for example, an α,β-unsaturated ester, α,β-unsaturated amide, α,β-unsaturated aldehyde, an α,β-unsaturated ketone, an α,β-unsaturated sulfone, an α,β-unsaturated sulfonate, α,β-unsaturated nitrile, and an α,β-unsaturated phosphate.

The present disclosure also contemplates methods for forming a polymer comprising polymerizing a monomer unit via a Baylis-Hillman type reaction to form the polymer, wherein the monomer unit comprises an electrophilic reactive group and a nucleophilic reactive group as set forth herein. According to certain embodiments, a polymerization reaction occurs by the repeated reaction of an electrophilic reactive group on one monomer unit with the nucleophilic reactive group on another monomer unit to form the polymer. Copolymers in which the different monomer units each contain an electrophilic reactive group and a nucleophilic reactive group (as described herein) are also contemplated.

According to other embodiments, the present disclosure also provides for an -(AB)ₙ— type alternating condensation polymer comprising a first monomer unit and a second monomer unit covalently bonded in an alternating pattern, wherein the first monomer unit reacts with the second monomer unit via a Baylis-Hillman type reaction to form the polymer. The first monomer unit comprises a first electrophilic reactive group and a second electrophilic reactive group, wherein the first electrophilic reactive group and the second electrophilic reactive group are each independently selected from the group consisting of an aldehyde, an aldimine, an α,β-unsaturated carbonyl, and an α,β-unsaturated nitrile. The second monomer unit comprises a first nucleophilic reactive group and a second nucleophilic reactive group, wherein the first nucleophilic reactive group and the second nucleophilic reactive group are each independently selected from the group consisting of an α,β-unsaturated ester, an α,β-unsaturated amide, an α,β-unsaturated aldehyde, an α,β-unsaturated ketone, an α,β-unsaturated sulfone, an α,β-unsaturated sulfonate, an α,β-unsaturated nitrile, and an α,β-unsaturated phosphate.

The present disclosure also contemplates methods for forming an -(AB)ₙ— type alternating condensation polymer comprising polymerizing a first monomer unit and a second monomer unit via a Baylis-Hillman type reaction to form the AB alternating condensation polymer. The first monomer unit comprises a first electrophilic reactive group and a second reactive electrophilic group, which may be the same or different, and the second monomer unit comprises a first nucleophilic reactive group and a second nucleophilic reactive group, which may be the same or different. Suitable electrophilic reactive groups and nucleophilic reactive groups are set forth in detail herein.

The monomer units of the various embodiments of the Baylis-Hillman type polymerization reactions may be derived, at least in part, from biobased materials. For example, acrylic acid made from glycerol according to the various methods disclosed herein, may be used to form acrylamines, acrylonitrile, acrolein, and various acrylates which may be used as biobased monomers. Alternatively, or in addition, biobased monomer units, such as, but not limited to, isosorbide diacrylate, hydroxymethyl furan, the acrylate (and other derivatives) of hydroxymethyl furfural, or diformylfuran may be prepared from biologically derived carbohydrates.

In other embodiments, bioderived polyfunctional carboxylic acids, such as citric acid, may be subjected to formation of esters with bioderived allyl alcohol to form materials suitable for bioderived thermoset polymers. In still other embodiments, the olefin groups of allyl esters may be subjected to oxidation to form epoxides suitable for use as bioderived epoxy resins.

The following examples illustrate various non-limiting embodiments of the compositions within the present disclosure and are not restrictive of the invention as otherwise described or claimed herein.

### EXAMPLES

### Example 1

Acrylic acid (which may be biobased) is esterified with bioderived alcohols, such as those disclosed in U.S. Patent Application Ser. Nos. 11/614,349, 60/913,572, 60/854,987, and 60/853,574 (the disclosures of which are incorporated in their entirety by reference herein); glycerol, ethanol, n-butanol, (from Acetone/Butanol fermentation), fusel oil alcohols (n-propanol, isobutyl alcohol, isoamyl alcohol), and derivatives of HMF.

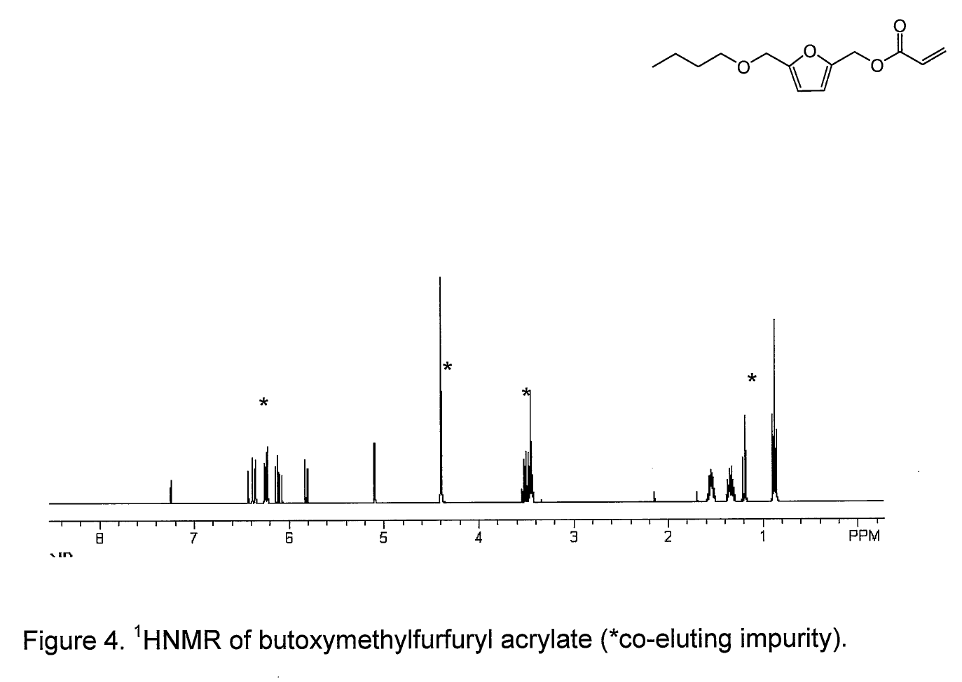

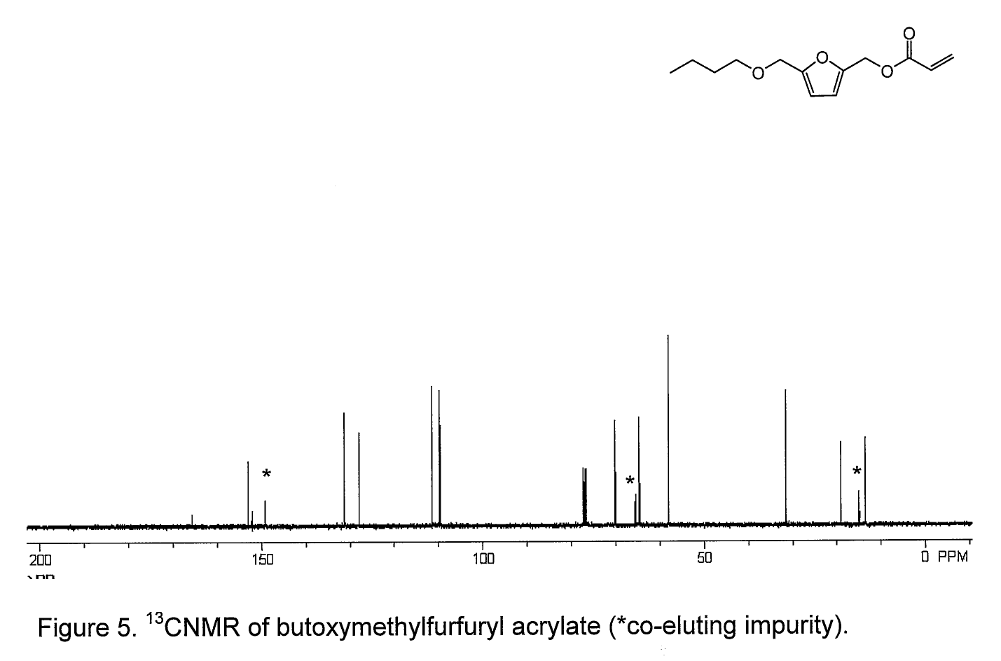

Synthesis of 5-butoxymethylfurfuryl acrylate (Scheme VIII): Immobilized Candida antarctica Lipase B (Novozymes 435, 50 mg) was added to a stirred solution of 5-butoxymethyl furfuryl alcohol (2 g, 10.8 mmol) in 5 mL methyl acrylate at 60° C. The mixture was stirred at 60° C. overnight. The lipase was removed from the mixture by filtration and excess methyl acrylate was removed in vacuo. The yellow colored residue was purified by passing through a silica gel column and eluting with 0-10% ethyl acetate/hexanes to give a colorless liquid. NMR analysis was performed on a Bruker 400 NMR instrument yielding the NMR spectra shown in FIGS. 4 and 5.

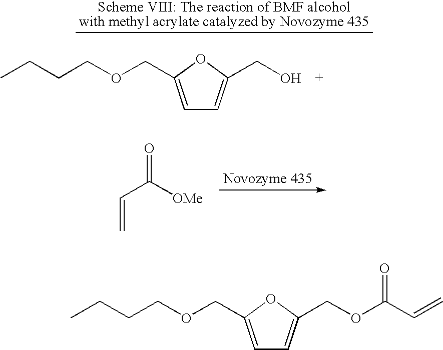

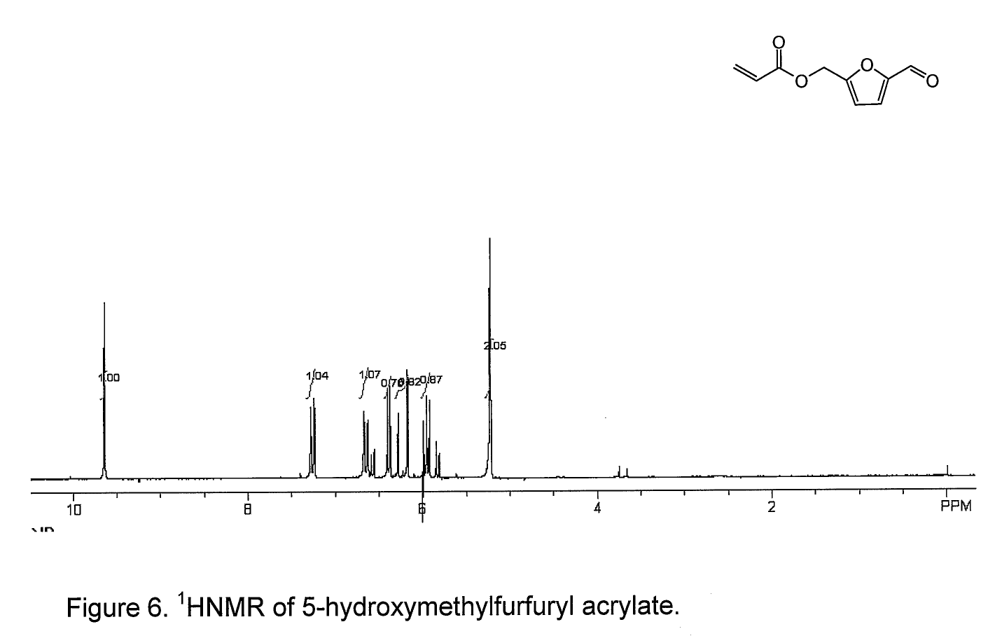

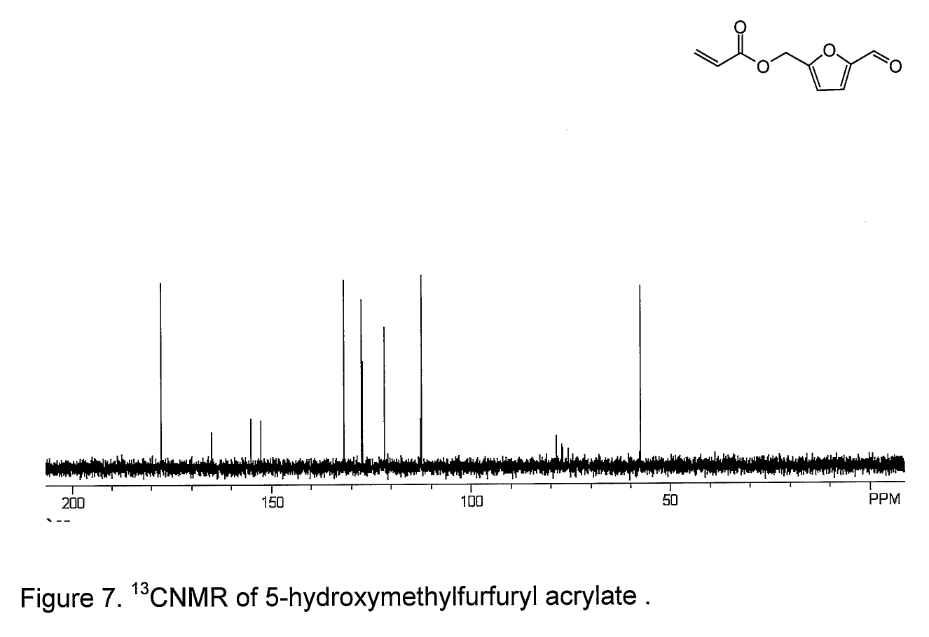

Synthesis of 5-hydroxymethylfurfuryl acrylate (Scheme IX): Triethylamine (2.5 mL, 15.9 mmol) was added to a solution of 5-hydroxymethyl furfural (2 g, 15.9 mmol) in tetrahydrofuran (THF, 40 mL) at 0° C. under N₂. The reaction mixture was stirred at 0° C. for 5 min and acryloyl chloride was added dropwise to this mixture. A white precipitate formed concomitantly with the addition of acryloyl chloride. After the addition was complete, the reaction temperature was increased to room temperature and the progress of the reaction was monitored by TLC (hexanes/ethyl acetate 2:8 v:v). The reaction was quenched using methanol after 0.5 hr. The reaction mixture was concentrated by removal of methanol in vacuo. The resulting pale yellow solid was taken up in ethyl acetate, and water was added to dissolve the solids. The aqueous layer was extracted twice with ethyl acetate. The combined organic layer was washed with brine, dried over Na₂SO₄ and concentrated in vacuo to give a yellow oil. The oil was purified on a silica gel column (0-50% ethyl acetate/hexanes). NMR analysis was performed on a Bruker 400 NMR instrument to give the NMR spectra shown in FIGS. 6 and 7.

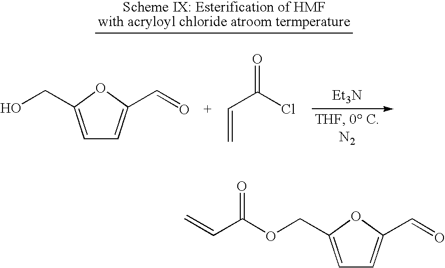

### Example 2

In this example, the diacrylate of bioderived furandimethanol (2B) was produced.

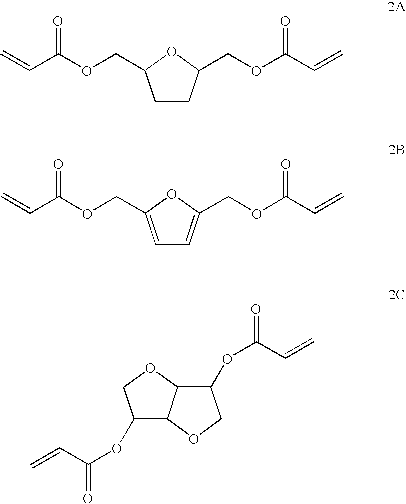

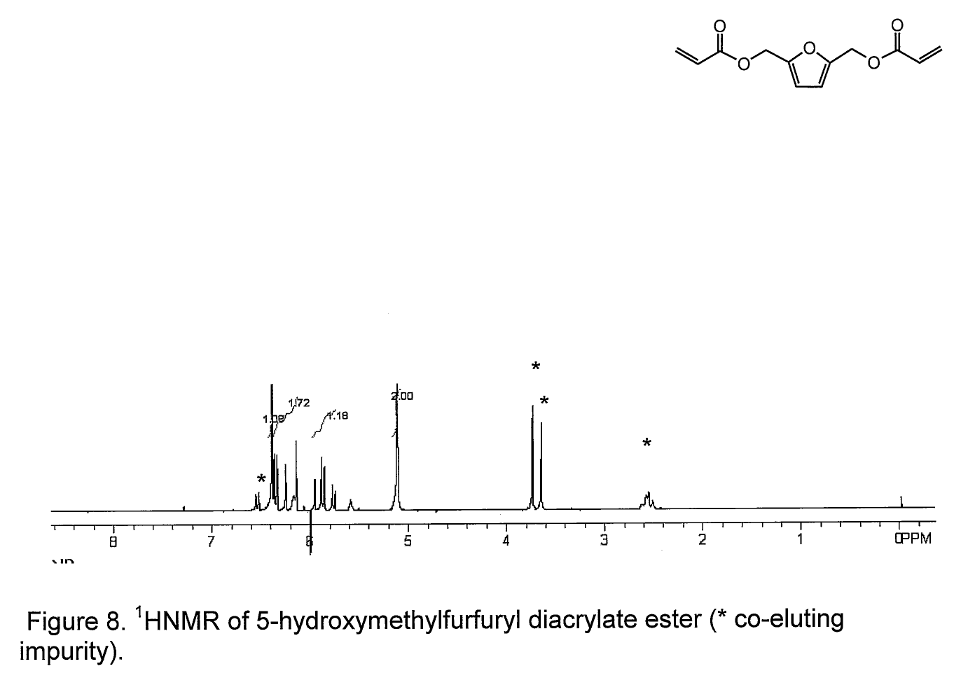

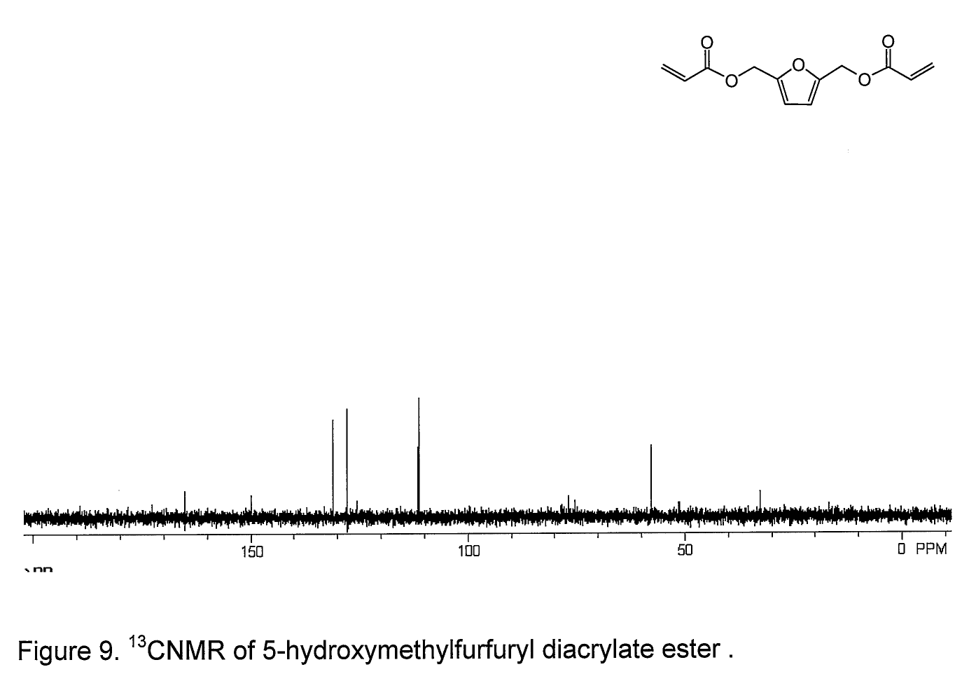

Synthesis of 5-hydroxymethylfurfuryl diacrylate ester (Scheme X): Triethylamine (5.5 mL, 37.5 mmol) was added to a solution of 5-hydroxymethylfurfuryl alcohol (2 g, 15 mmol) in THF (40 mL) at 0° C. under N₂. The mixture was stirred at 0° C. for 5 min and acryloyl chloride (3.16 mL, 37.5 mmol) was added. The reaction mixture was stirred at 0° C. and monitored by TLC (20% ethyl acetate/hexanes). The reaction was quenched after 0.5 hr with methanol and the complete reaction mixture was concentrated in vacuo. The remaining pale yellow solid was taken up in ethyl acetate and water was added to dissolve the solids. The aqueous layer was extracted twice with ethyl acetate. The combined organic layer was washed with brine, dried over Na₂SO₄ and concentrated in vacuo to give a yellow oil. The oil was purified on a silica gel column (0-50% ethyl acetate/hexanes). ¹H NMR analysis was performed on an EFT NMR instrument (CDCl₃, 90 MHz) to give NMR spectra shown in FIGS. 8 and 9.

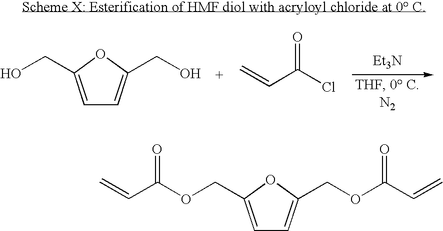

### Example 3

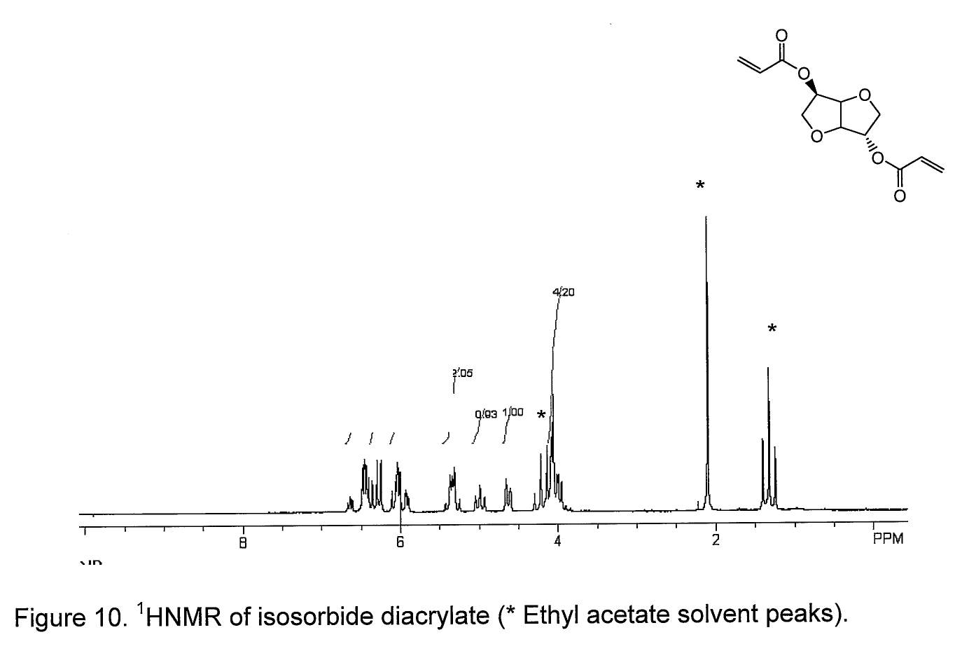

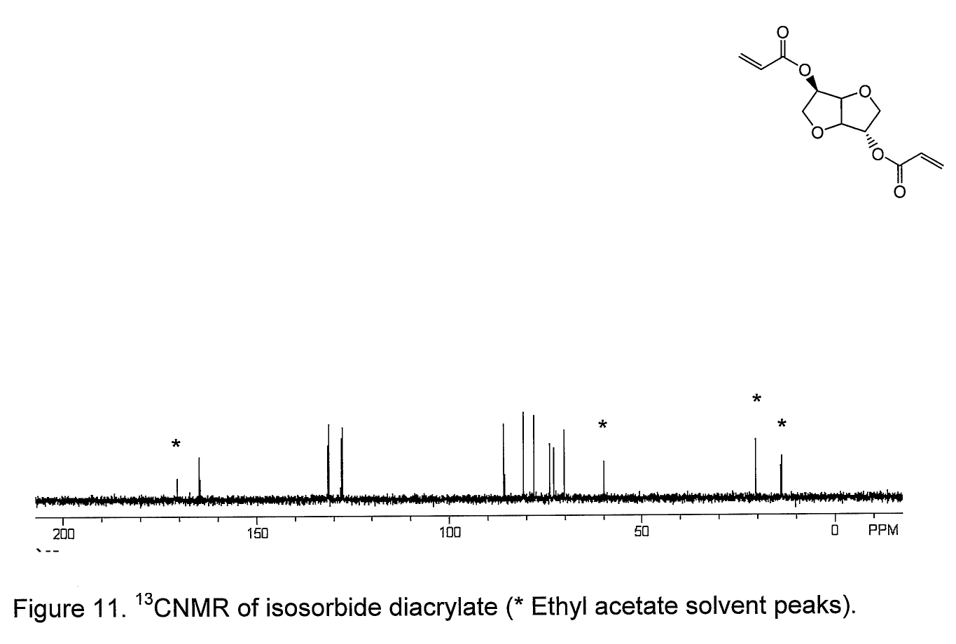

In this example, the diacrylate of bioderived isosorbide (2C) was produced. A 250 mL 3-neck flask was charged with 60% wt sodium hydride (1.35 g, 34.2 mmol), 5 mL hexanes and 30 mL dry THF at 0° C. under nitrogen atmosphere. The mixture was stirred for 5 min at 0° C. A solution of bioderived isosorbide (2 g, 13.6 mmol) in 20 mL dry THF was added dropwise into this solution. The mixture was stirred for 10 min at 0° C. Acryloyl chloride (2.75 mL, 34.2 mmol) was added dropwise into the above reaction mixture. The temperature of the reaction mixture was slowly increased to room temperature and progress of the reaction was monitored by TLC. After 8 hours, the reaction mixture was cooled to 0° C. and 30 mL of water was added dropwise to quench the reaction. The organic layer was separated and the aqueous phase was extracted twice with ethyl acetate. The combined organic layer was dried over Na₂SO₄ and concentrated in vacuo to give a colorless oil. The oil was purified on a silica gel column (0-50% EtOAc/Hexanes) to give a colorless oil (1.1 g, 29% yield (mol/mol)) that polymerized to form a gel upon complete removal of solvents in vacuo. ¹H NMR analysis was performed on an EFT NMR instrument (CDCl3, 90 MHz) to give the NMR spectra shown in FIGS. 10 and 11.

In a prophetic example, the bioderived diacrylate of 2,5-bishydroxymethyl (tetrahydrofuran) (2A) can be produced in a similar manner.

### Example 4

In a prophetic example, bioderived diacrylate can undergo ring-opening metathesis with cyclic olefins to produce olefin macrocycles by ring expansion to make repeating A,B-alternating olefin polymers (biomass-derived diacrylates of butanediol can be polymerized with cyclooctene). Cyclooctene, the bioderived diacrylate (e.g. butanediol diacrylate ester) and the material produced in example 2 are charged in a round bottom flask under an inert atmosphere. A ring-opening metathesis polymerization catalyst as described in PCT Published No. WO2003/070779 (the disclosure of which is incorporated in its entirety by reference herein) is added into the reaction mixture and the degassed mixture is heated at 80° C. until polymerization occurs. Methanol is added to precipitate the polymer. The polymer is characterized by ¹H NMR and GPC.

### Example 5

In a prophetic example, the diacrylamide of 2,5-bisaminomethylfuran is prepared. 2,5-Bishydroxymethylfuran is prepared by selective hydrogenation of bioderived hydroxymethylfurfural substantially as described in U.S. Pat. No. 3,040,062 (the disclosure of which is incorporated in its entirety by reference herein). 2,5-Bishydroxymethylfuran is converted to the corresponding diacrylamide using a method similar to that described by Parris in Organic Syntheses, Coll. Vol. 5, 1973, p.73 and Vol. 42, 1962, p. 16 (the disclosures of which are incorporated in their entirety by reference herein). Acrylonitrile (401.1 g, 7.56 moles) is added to a two liter, 3-necked, round-bottomed flask equipped with mechanical agitation, a dropping funnel, and a thermocouple. The flask is cooled in an ice-water bath and 100 mL of concentrated sulfuric acid is added dropwise over about 1.5 hours while the temperature in maintained below 5° C. 2,5-Bishydroxymethylfuran (128 g, 1 mol) is then added dropwise over two hours while maintaining the temperature between 0-5° C. The temperature of the resulting mixture is held below 5° C. for 5 hours and then the temperature is increased slowly to room temperature and stirred for 2 days. The reaction mixture is poured over 2 liters of crushed ice and extracted with 1 liter of ethyl acetate split into 4×250 mL volumes. The aqueous phase is separated and the ethyl acetate phase is washed with a saturated solution of sodium chloride followed by neutralization using a saturated solution of sodium bicarbonate to yield a neutralized ethyl acetate extract. The ethyl acetate extract is dried over anhydrous magnesium sulfate, filtered and the solvent is removed under reduced pressure on a rotary evaporator to yield the diacrylamide of 2,5-bisaminomethylfuran (4A). Structures 4B, 4C, and 4D may be synthesized by a similar process, using other reductive amination reactions. The products can be further purified by chromatography, distillation, or recrystallization techniques.

### Amide Derivatives:

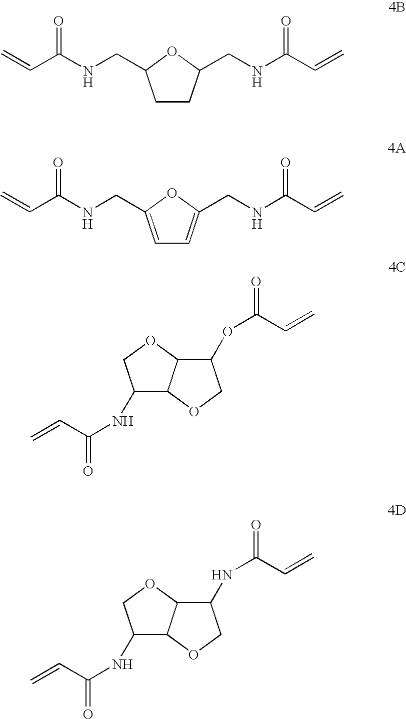

### Example 6

In a prophetic example, dicarboxylic acids are prepared as described in U.S. Pat. No. 5,254,466 (the disclosure of which is incorporated in its entirety by reference herein). About 3.0 to about 4.0 mmol of a C18 monounsaturated diacid (1,18-octadecen-9E-dioic acid) is dissolved in methanol, followed by neutralization with about 0.3 to about 0.6 mL of 1 M sodium methoxide. The solution is placed in an anodic coupling cell equipped with platinum electrodes (1.5 cm×1.5 cm and 2.5 cm×1.0 cm, spaced <0.5 cm apart). A potentiostat/galvanostat with a 100-V maximum compliance voltage (Princeton Applied Research Model 173) is applied to maintain a constant current between the platinum electrodes in the anodic coupling cell. The anodic coupling is performed in a water-jacketed cell to maintain a constant temperature, which is generally set at a temperature between about 40° C. and about 60° C. A magnetic stir bar is used to agitate the reaction mixture. The electrolysis is stopped, when an electrical charge equivalent to 1.3 Faradays per mole of the starting acid at the specified current density (generally between about 0.05 and 0.12 A cm⁻², or about 0.18-0.63 A) passes through the reaction mixture. The reaction mixture is acidified with a few drops of concentrated HCl, which converts methoxide to methanol and protonates the carboxylate ions. Following evaporation of methanol, the crude product is dissolved in 50 mL of hexanes, transferred to a 125 mL separatory funnel, and washed with three 75 mL portions of water at 60° C. A mixture of the desired cyclic product, linear coupled polymer/oligomer and disproportionated compounds is obtained (Scheme XI). This mixture can be separated by chromatography, distillation, or recrystallization and any combination of these techniques.

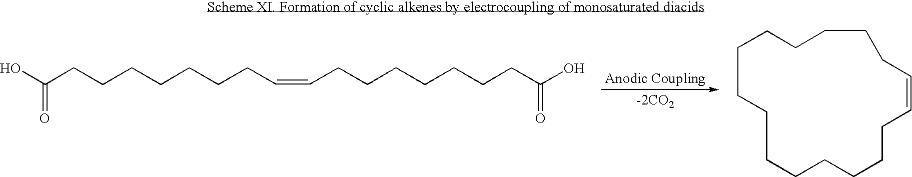

### Example 7

In a prophetic example, ring-opening metathesis (Scheme XII) using ring-opening metathesis polymerization catalyst such as those described in PCT Publication No. WO2003/070779 (the disclosure of which is incorporated in its entirety by reference herein) is performed. Isosorbide diacrylate as produced in Example 3 is coupled with cyclic olefins produced from anodic coupling of C18:1 diacid as described in Example 6. The product is precipitated in methanol and characterized by ¹H NMR and GPC.

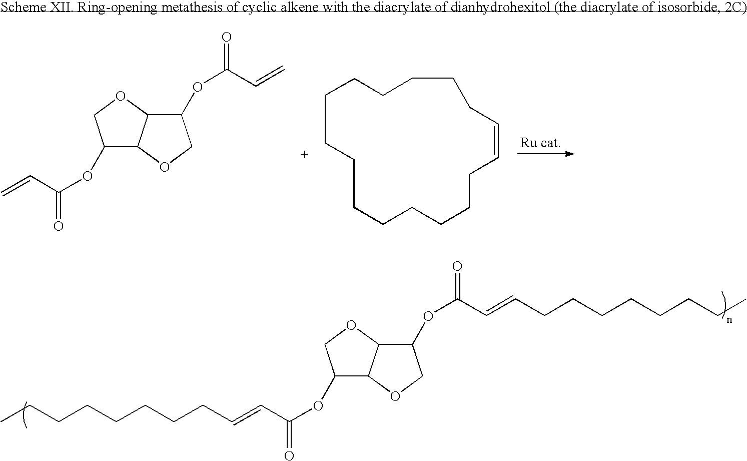

### Example 8

In a prophetic example, bioderived dienes are produced. The diol of an α,ω-dicarboxylic acid is produced as set forth in Example 11 by the reduction of the carboxylic acid moieties of the diacid and the diol is heated with 1% Amberlite 35 at 130° C. under vacuum. The reaction is cooled to room temperature and the catalyst removed by filtration. The catalyst is washed with hexanes and the combined filtrate is concentrated in vacuo to give the diene (Scheme XIV).

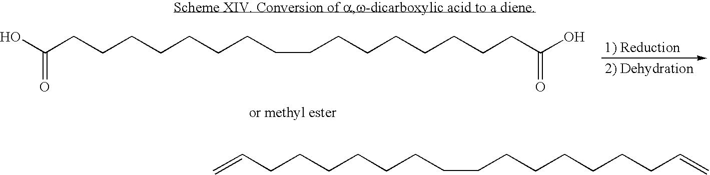

### Example 9

In a prophetic example, polymers from bioderived dienes, such as, the dienes produced by the process in Example 8, are produced by an ADMET-type polymerization (Scheme XV). In a prophetic example, the bioderived diene produced in Example 8 is added under an inert atmosphere to a flame dried flask equipped with a vacuum valve. An ADMET-type polymerization catalyst is then added without solvent, under inert atmosphere, and the mixture is stirred at room temperature. Vacuum is applied to remove the evolving ethylene and the mixture is stirred until the solution become viscous. The mixture is warmed to 50-55° C. and stirring is continued until stirring is no longer possible. Polymerization is quenched by exposure to air. The viscous solution is dissolved in THF and the product analyzed by ¹H NMR and gel permeation chromatography.

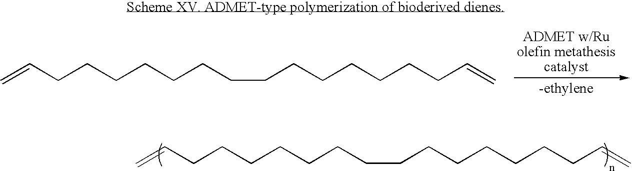

In another prophetic example, a bioderived long chain polyunsaturated hydrocarbon (C₂₂-C₅₀) produced by anodic coupling for bioderived unsaturated fatty acids, such as described in U.S. Patent Application Publication No. 2006/0149085 A1 (the disclosure of which is incorporated in its entirety by reference herein) is coupled using an ADMET-type polymerization catalyst to give a polymer of high molecular weight (Scheme XVI).

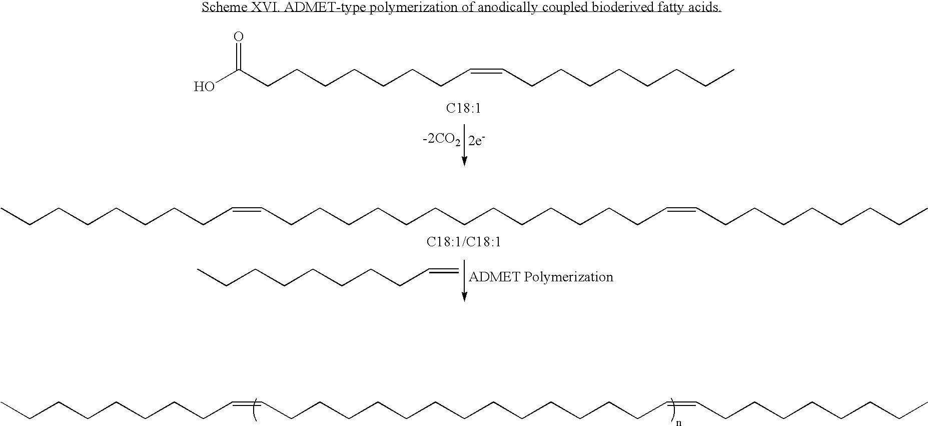

The polymers are expected to range in molecular weight from the C18:1-C18:1 coupling product to about 40,000 g/mol., with a polydispersity index of from about 1 to about 3. These polymers will make valuable feedstocks for further functionalization to make intermediates, plasticizers, coating, polyurethanes and foam. This will produce bioderived displaced terminal alkenes.

### Example 10

In a prophetic example, bioderived polymers are prepared substantially according to Example 9 (Scheme XVI), are subjected to one or more of hydroformylation, hydroxylation, epoxidization, heat-bodying/polymerization, or hydrogenation (Scheme XVII).

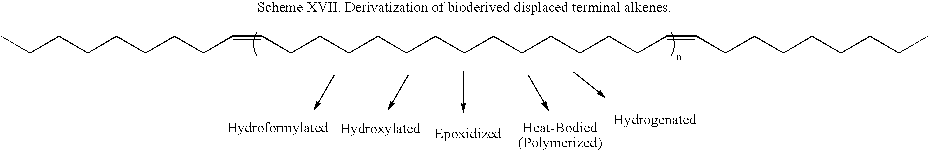

### Example 11

In a prophetic example, the C18:1 diacid prepared in Example 6 (prepared as described in U.S. Pat. No. 5,254,466, the disclosure of which is incorporated in its entirety by reference herein) may be reduced to diol, and esterified to form a biomass-derived diacrylate, which may be used as a co-monomer in an olefin metathesis polymerization with a cyclic olefin using a Ruthenium olefin metathesis catalyst.

Synthesis of bioderived diacrylate (Scheme XVIII). E. coli BL21(DE3) RP/pPV2.83 expressing the Carboxylic Acid Reductase (car) gene is cultivated in M9 glucose medium. The M9 medium (1 L) consists of 6 g Na₂HPO₄, 3 g KH₂PO₄, 0.5 g NaCl, 1 g NH₄Cl, 0.1% yeast extract, 0.4% glucose, 20 mg of D-Pantothenic acid hemi-calcium salt, 40 mg L-cysteine, 3 mL trace elements, 40 μg/mL ampicillin and 1 mM MgSO₄. A trace element solution consisting of 2.7% (w/v) FeCl₂.6H₂O, 0.2% (w/v), ZnCl₂.4H₂O, 0.2% (w/v) CoCl₂.6H₂O, 0.2% (w/v) Na₂MoO₄.2H₂O, 0.1% (w/v) CaCl₂.2H₂O, 0.1% (w/v) CuCl₂, 0.1% (w/v) MnCl₂.4H₂O, 10% (v/v) conc. HCl is provided. A single colony of BL21(DE3) RP/pPV2.83 is used to inoculate 5 mL of M9 medium and incubated at 37° C. for 12 h to form an overnight culture. The overnight culture (1%) is transferred to 100 mL of M9 medium in a shake flask and incubated at 37° C. with shaking at 250 rpm. Dicarboxylic acid, prepared as described in U.S. Pat. No. 5,254,466, is added to the shake flask after 4 h of incubation. After incubating in the shake flask for 24 hours, the reduced diol is recovered from the fermentation broth by extraction with hexanes. The diol is purified on a silica gel column (ethyl acetate/hexanes, 0-40% v/v). The diacrylate of the recovered diol is synthesized substantially as in Example 1. The recovered diol is mixed with excess methyl acrylate and immobilized lipase (Novozymes 435) is added to the solution. The mixture is stirred at 60° C. for 12 h and the progress of the reaction is monitored by thin layer chromatography (TLC) (ethyl acetate/hexanes, 4/6 v/v). The immobilized lipase is removed by filtration, excess methyl acrylate is removed under vacuum, and the diacrylate ester of the fatty diol is purified on a silica gel column (ethyl acetate/hexanes, 0-40% v/v). Other suitable diacids including polyunsaturated diacids, such as those prepared from linoleic acid, linolenic acid, arachidonic acid, eicosapentaenoic acid, docosahexaenoic acid and others, as well as monoacrylate esters may be prepared by similar methods.

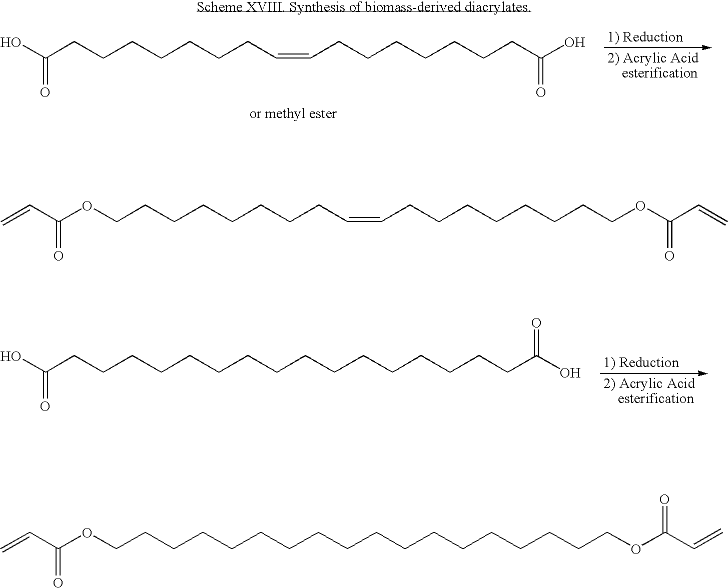

### Example 12

In a prophetic example, bioderived fatty acids can be hydroformylated/hydrogenated (as described in U.S. Pat. No. 3,210,325, the disclosure of which is incorporated in its entirety by reference herein) and esterified with bioderived acrylic acid to form bioderived diacrylates (Scheme XIX). Bioderived fatty acids are hydroformylated substantially as described in Example 10. The hydroformylated fatty acid is used as a substrate for reduction with E. coli BL21(DE3) RP/pPV2.83 substantially as described in Example 11 to give a branched diol. The branched diols are esterified with methyl acrylate and Novozymes 435 as catalyst as described in Example 1 to form the diacrylates. Other suitable bioderived fatty acids including polyunsaturated diacids, such as those prepared from linoleic acid, linolenic acid, arachidonic acid, eicosapentaenoic acid, docosahexaenoic acid and others, as well as monoacrylate esters may be prepared by similar methods.

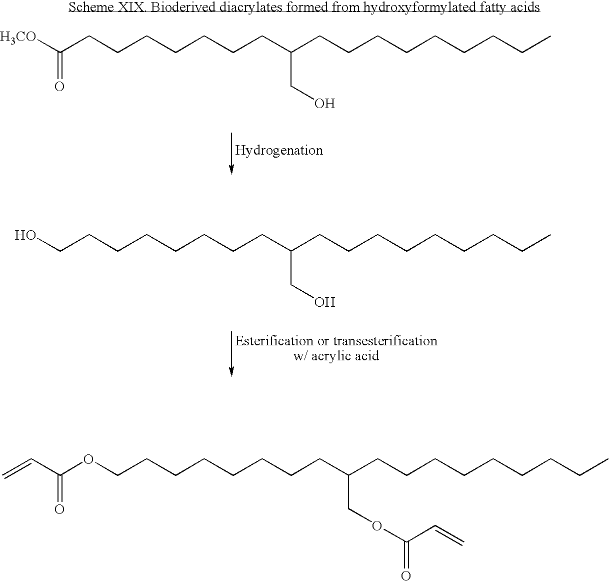

### Example 13

In a prophetic example, bioderived epoxidized fatty alcohols or fatty acid esters selectively hydrogenated are esterified with bioderived acrylic acid to yield bioderived branched diacrylates (Scheme XX).

Bioderived epoxidized fatty acid are used as substrates for reduction with E. coli BL21(DE3) RP/pPV2.83 substantially as described in Example 11 to give epoxidized fatty alcohol. The epoxidized fatty alcohol is hydrogenated according to the procedure described by Rao et. al (JAOCS,1965, 45(5), 408, the disclosure of which is incorporated in its entirety by reference herein) to produce a diol. The diol is esterified with bioderived methyl acrylate and Novozymes 435 as catalyst, substantially as described in Example 1 to form a bioderived branched diacrylate. Other suitable bioderived fatty acids include monounsaturated fatty acids, such as palmitoleic acid, oleic acid, and erucic acid, and polyunsaturated diacids, such as those prepared from linoleic acid, linolenic acid, arachidonic acid, eicosapentaenoic acid, docosahexaenoic acid and others. Bioderived branched acrylates may be formed at all possible hydroxyl groups, or free hydroxyl groups may remain, so that mono-, di-, tri-, etc acrylate esters may be prepared.

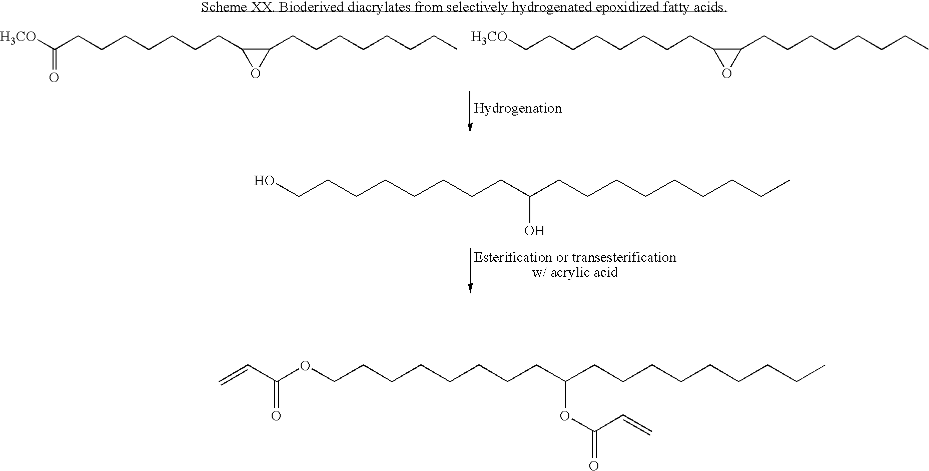

### Example 14

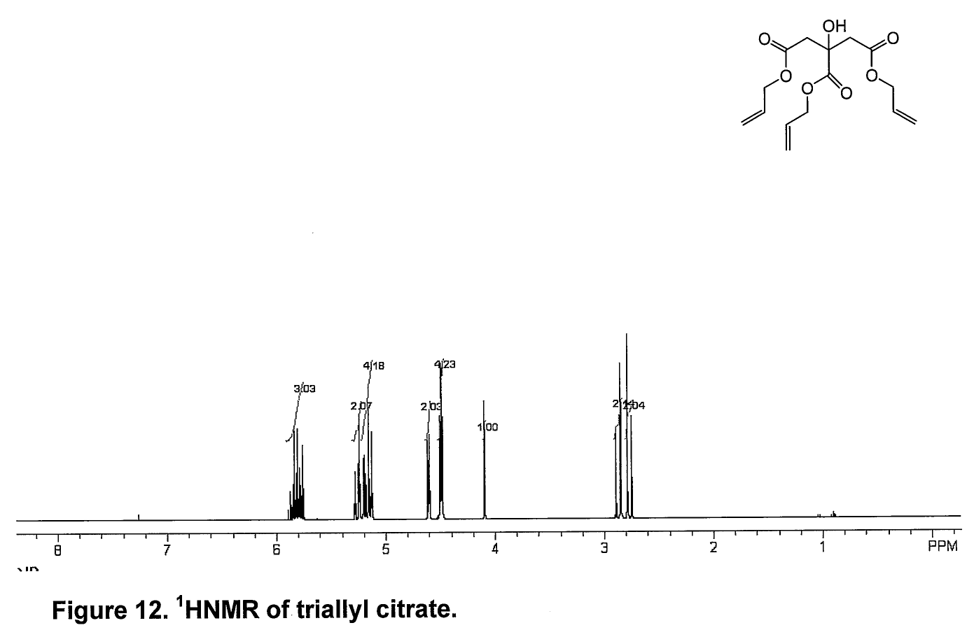

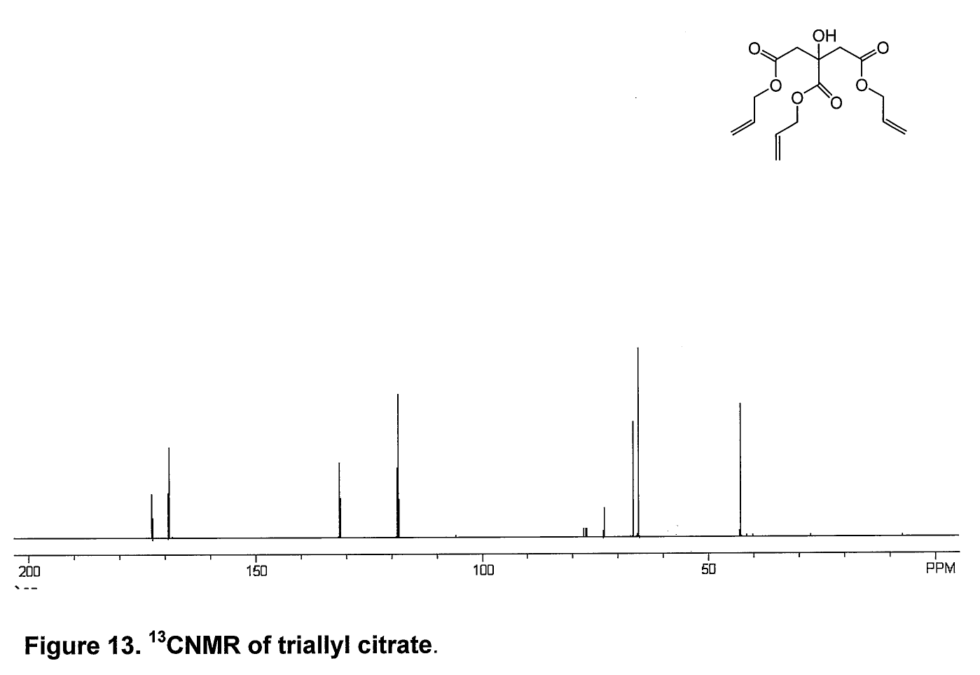

Synthesis of triallylcitrate (Scheme XXI): A 50 mL round bottom flask fitted with a Dean-Stark trap and condenser was charged with citric acid (5 g, 26 mmol), Amberlyst 35 (0.5 g) and allyl alcohol (15 mL). The slurry was stirred and heated to 105° C. and the progress of the reaction was monitored by TLC (Ethyl acetate:Hexanes:Acetic acid, 4:6:0.1 v/v/v). After 12 h, the reaction mixture was cooled to room temperature. The catalyst was filtered and excess allyl alcohol was evaporated in vacuo. The residue was purified by chromatography on a silica gel column (Ethyl acetate/Hexanes, 0-50%) to afford a dark yellow oil (2.2 g, 27% yield (mol/mol)). ¹H NMR analysis was carried out on an EFT NMR instrument (CDCl₃, 90 MHz) to yield the spectra shown in FIG. 12 and FIG. 13.

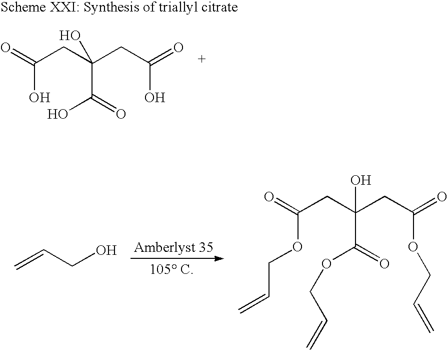

### Example 15

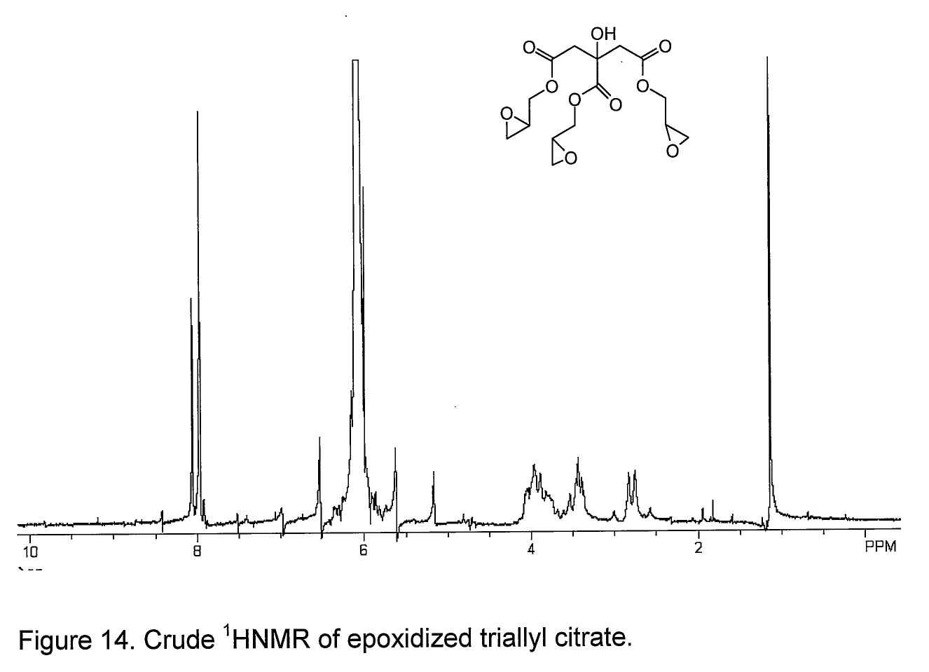

Synthesis of citrate esters of propylene oxide (Scheme XXII). A mixture of allyl citrate (1 g, 3.2 mmol prepared as in Example 14), 0.5 mL formic acid, and 1 mL 50% H₂O₂ was stirred at room temperature. The progress of the reaction was monitored by TLC (Ethyl acetate: Hexanes, 6:4 v/v). ¹H NMR analysis was carried out on an EFT NMR instrument (CDCl₃, 90 MHz) to yield the spectra shown in FIG. 14, indicating oxirane formation.

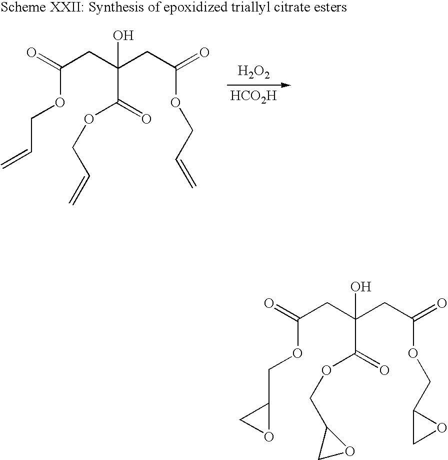

### Example 16

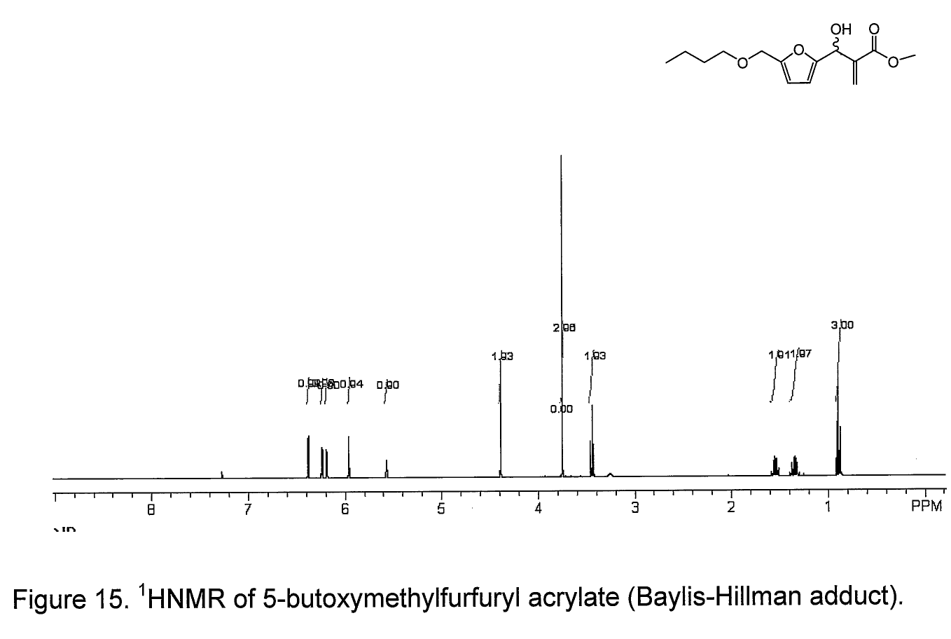

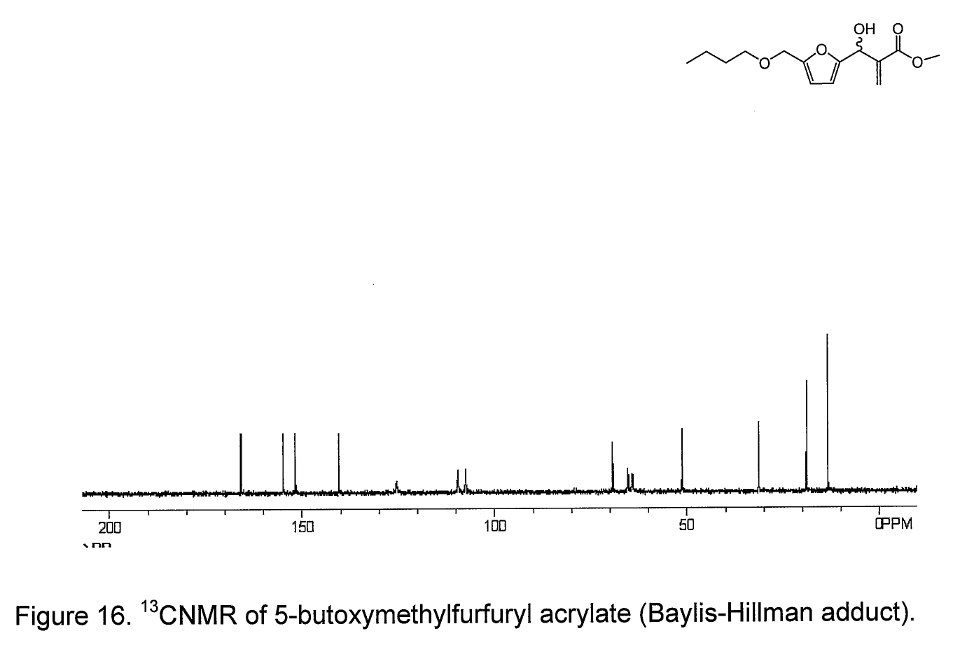

Synthesis of the Baylis-Hillman adduct of 5-butoxymethylfurfural with methyl acrylate (Scheme XXIII). 5-Butoxymethyl furfural (BMF, 2 g, 10.9 mmol) in methanol (10.9 mL, 1 M) was stirred, and 45% (w/v) aqueous trimethyl amine (0.805 g, 13.6 mmol) was added. The solution was stirred at room temperature for 2 min. To this solution, methyl acrylate (2.83 g, 32.7 mmol) was added slowly and the resulting solution was stirred at room temperature for 1 day. The progress of the reaction was monitored by Thin Layer Chromatography (TLC) (Hexanes: Ethyl acetate, 6:4 v:v). The color of the reaction mixture turned from pale to dark yellow during the course of the reaction. The reaction was quenched by adding 20 mL of ethyl acetate and 5 mL H₂O. The organic layer was separated and the aqueous layer was extracted twice with ethyl acetate. The combined organic layer was dried over sodium sulfate and concentrated in vacuo. The product was purified on a silica gel column (Ethyl acetate/Hexanes, 0-30%) to afford a yellow oil (2 g, 68% yield). ¹H NMR analysis was carried out on a Bruker 400 NMR instrument (CDCl₃, 400 MHz) to yield the spectra shown in FIGS. 15 and 16, indicating the presence of pure Baylis-Hillman adduct of 5-butoxymethyl furfural with methyl acrylate.

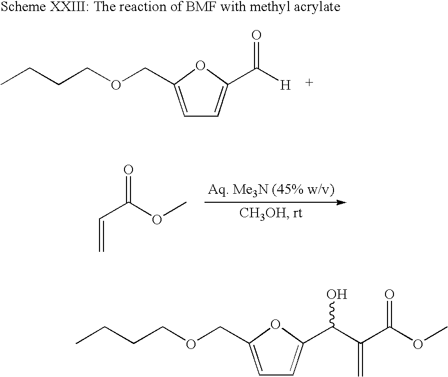

### Example 17

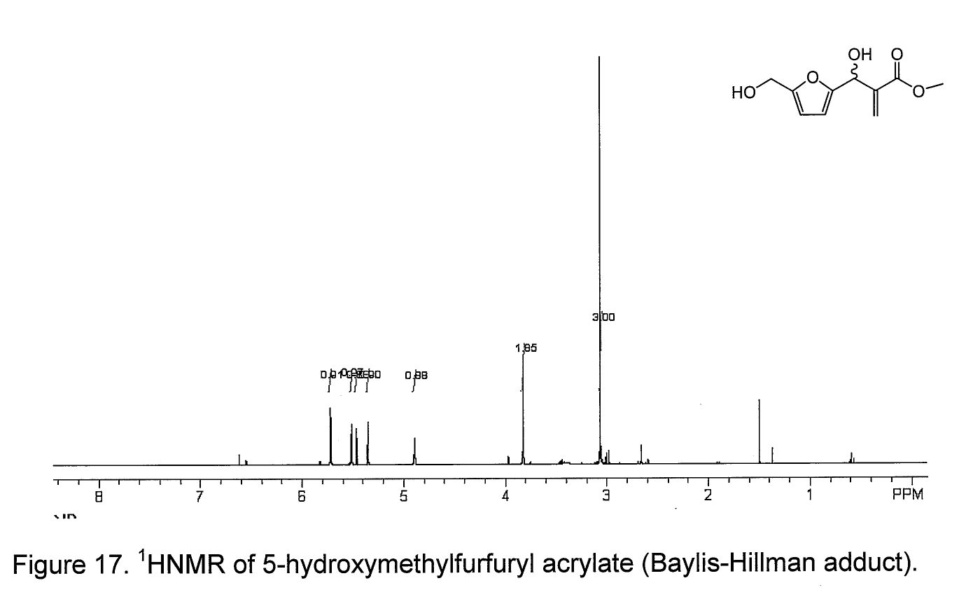

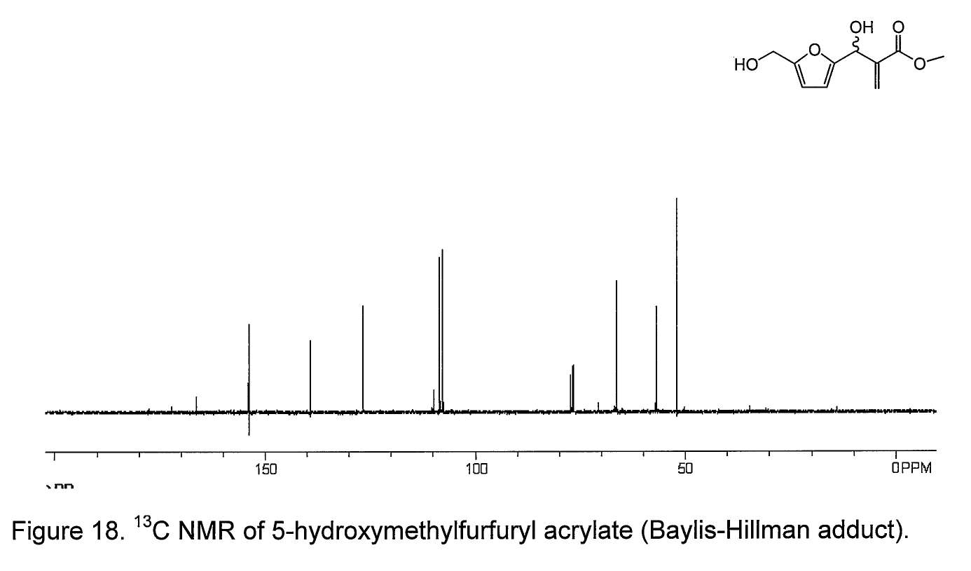

The Baylis-Hillman adduct of 5-hydroxymethyl furfural (HMF) with methyl acrylate was synthesized (Scheme XXIV) essentially using the procedure described in Example 16, except that 5-hydroxymethyl furfural (2 g, 10.9 mmol) was used instead of 5-butoxymethyl furfural. The progress of the reaction was monitored by TLC (Hexane:Ethyl acetate, 2:8 v:v). The reaction turned from pale to dark yellow in color during the course of the reaction. The reaction was quenched, separated, and dried as with the BMF adduct (Example 16). The product was purified on a silica gel column (Ethyl acetate/Hexanes, 0-70%) to afford a yellow oil (2 g, 68% yield). ¹H NMR analysis was carried out on a Bruker 400 NMR instrument (CDCl₃, 400 MHz) to yield the spectra shown in FIG. 17 and FIG. 18, indicating the presence of pure Baylis-Hillman adduct of 5-hydroxymethyl furfural with methyl acrylate.

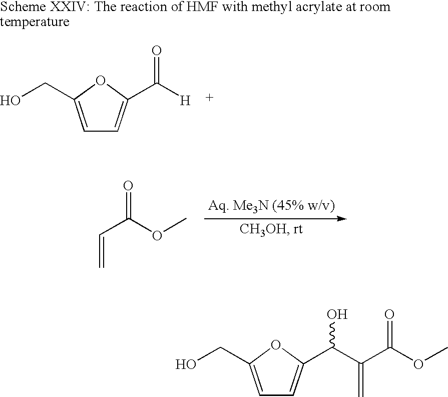

### Example 18

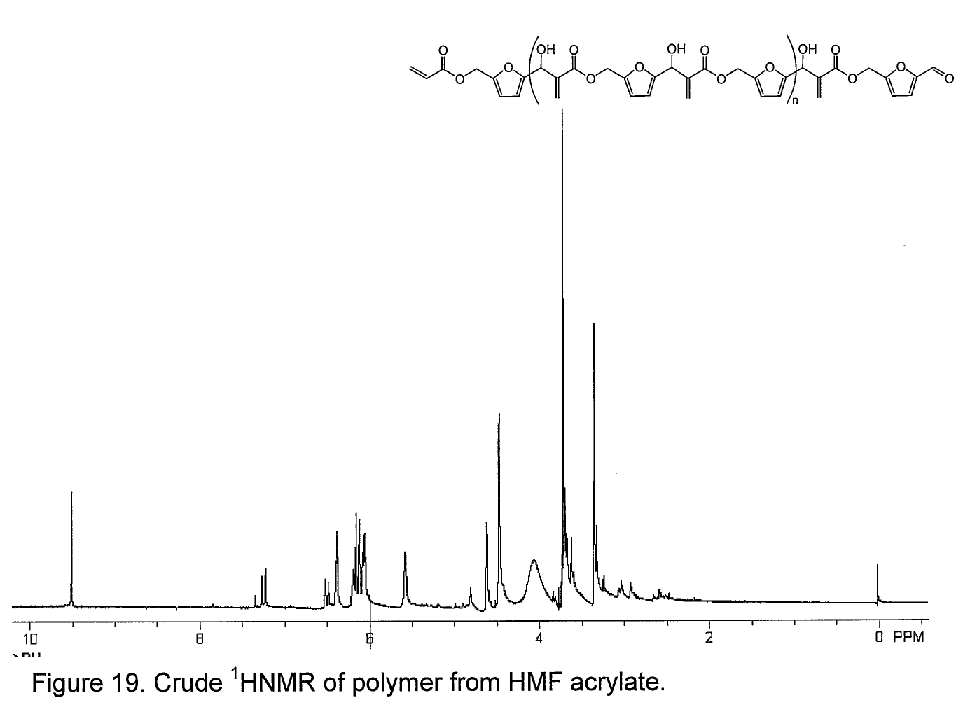

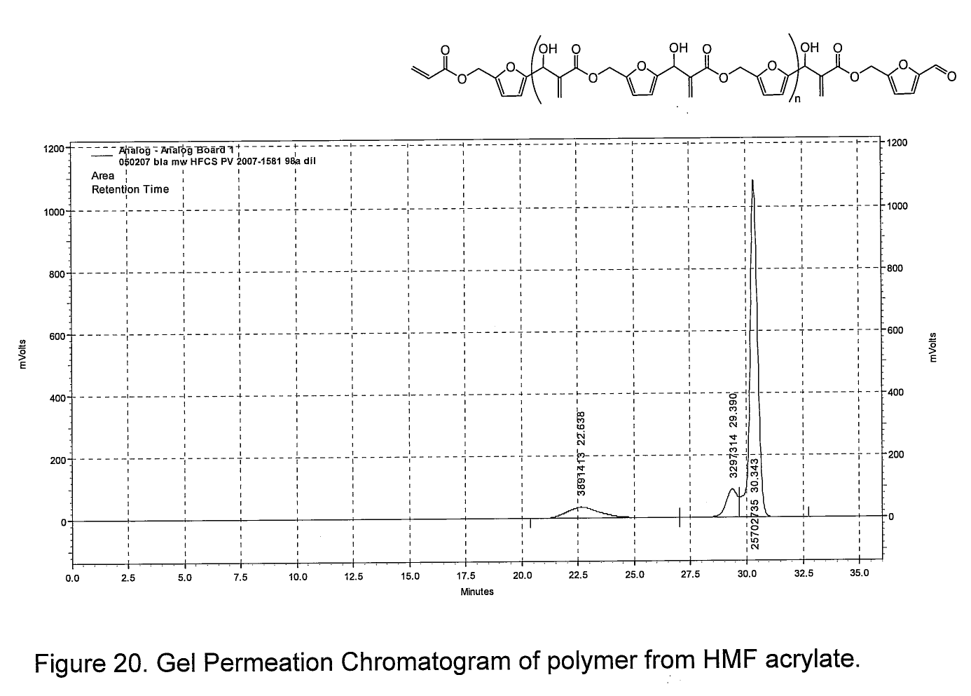

Polymers from HMF acrylate: 5-Hydroxymethylfurfuryl acrylate synthesized in Example 1 was self condensed to give a Baylis-Hillman adduct using the procedure substantially as described in Example 16. Crude ¹H NMR showed disappearance of starting material and production of Baylis-Hillman adduct (FIG. 19) and the reaction product had a polydispersity index of 1.4. TLC (Ethyl acetate/Hexane, 40% v/v) showed disappearance of the starting material and development of a polar compound of Rf 0.2 indicating development of product of high polarity (Scheme XXV). Gel permeation chromatography showed a polymer having an average molecular weight of 63414 g/mol (FIG. 20).

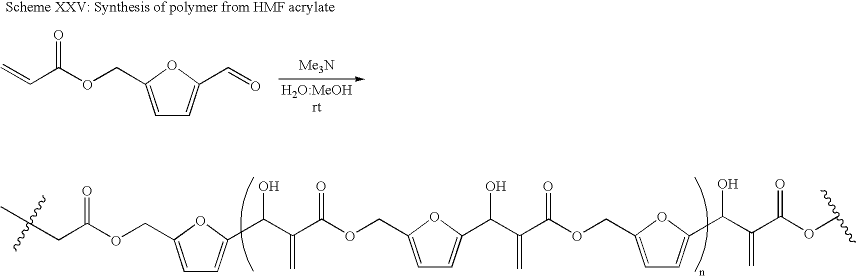

### Example 19

Polymers from condensation of diformylfuran (DFF) and the diacrylate of 2,5-dihydroxymethylfuran: In a prophetic example, DFF is synthesized from HMF according to the procedure described in PCT Publication No. WO2006/063287, the disclosure of which is specifically incorporated in its entirety by reference herein. Condensation of DFF with the diacrylate of 2,5-dihydroxymethylfuran or diacrylamides as produced in Examples 2 and 5, respectively, according to the Baylis-Hillman procedure described in Example 16 give an A,B-alternating condensation polymer such as that depicted in Scheme XXVI.

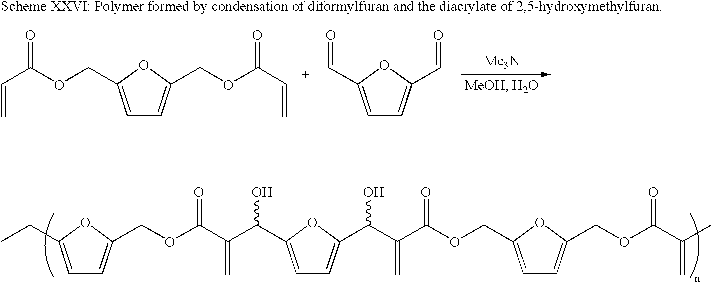

### Example 20

Polymer from condensation of diformylfuran (DFF) and isosorbide diacrylate: In a prophetic example, DFF is condensed with isosorbide diacrylate (produced as described in Example 3) according to the Baylis-Hillman procedure described in Example 16 to give A,B-alternating condensation polymer such as those depicted in Scheme XXVII.

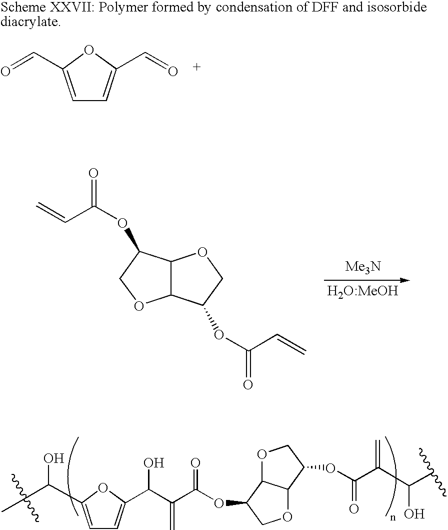

### Example 21

Polymer from condensation of diformylfuran (DFF) and diacrylamide of2,5-bisaminomethylfuran: In a prophetic example, DFF is condensed with the diacrylamide of 2,5-bisaminomethylfuran (produced according to Example 5) or with the diacrylamide of 2,5-bisaminomethyl tetrahydrofuran according to the Baylis-Hillman procedure described in Example 16 to yield A,B-alternating condensation polymer such as those depicted in Scheme XXVIII.

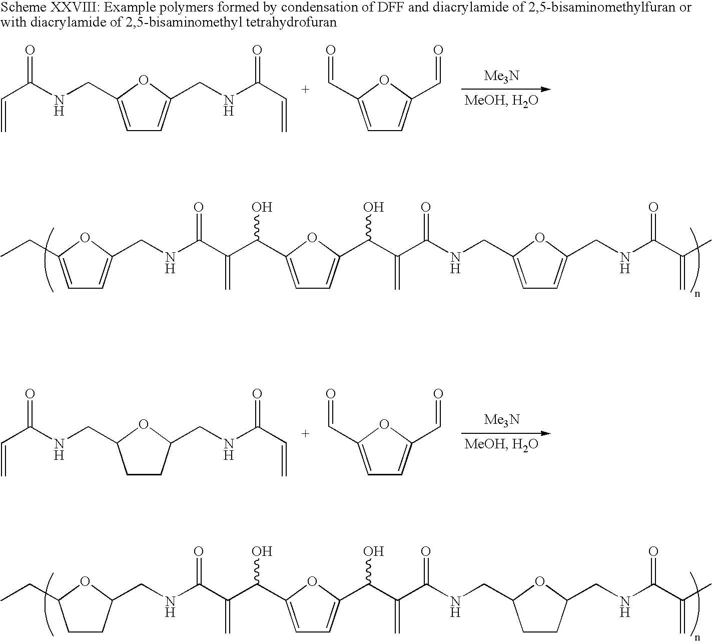

### Example 22

Polymer from condensation of diformylfuran (DFF) and diacrylamide of isosorbide: In a prophetic example, DFF is condensed with the diacrylamide of isosorbide according to the Baylis-Hillman procedure described in Example 16 to yield an A,B-alternating polymeric compound such as that depicted in Scheme XXIX.

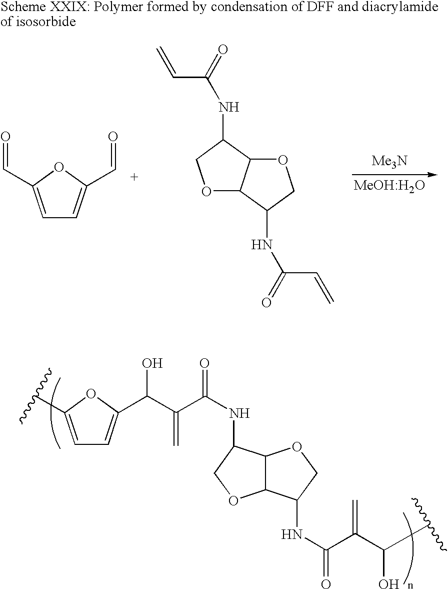

### Example 23

Polymer from condensation of diacrylate of 2,5-bishydroxymethylfuran: In a prophetic example, the diacrylate of 2,5-bisaminomethylfuran undergoes self-condensation according to the procedure described in example 16 to give a polymeric compound such as that depicted in Scheme XXX.

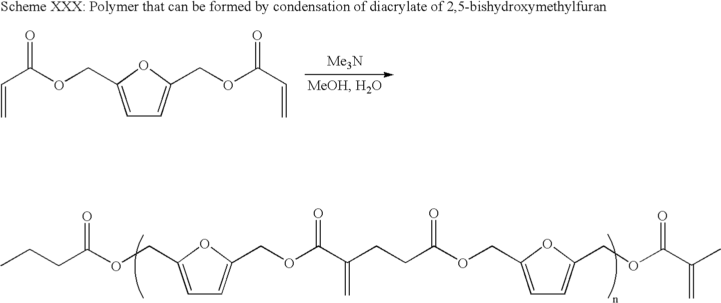

Although the foregoing description has necessarily presented a limited number of exemplary embodiments of the invention, those of ordinary skill in the relevant art will appreciate that various changes in the components, details, materials, and process parameters of the examples that have been herein described and illustrated in order to explain the nature of the invention may be made by those skilled in the art, and all such modifications will remain within the principle and scope of the invention as expressed herein in the appended claims. It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the principle and scope of the invention, as defined by the claims.

1-27. (canceled)

28. A polymer comprising:
a product from a metathesis polymerization reaction of a bioderived olefin and an acrylate ester of a bioderived alcohol,
wherein the acrylate ester is produced by reacting the bioderived alcohol with at least one equivalent of acrylic acid produced from bioderived glycerol,
wherein the polymer is 100% biobased as determined by ASTM International Radioisotope Method D 6866.

29. The polymer of claim 28, wherein the bioderived diol is selected from the group consisting of isosorbide, 2,5-bishydroxymethyltetrahydrofuran, 2,5-bishydroxymethylfuran, a diol produced from the hydrogenation of a hydroformylated fatty acid, a diol produced from the hydrogenation of an epoxidized fatty acid ester or fatty acid alcohol, a diol produced from the reduction of an a,o)-dicarboxylic acid, and mixtures thereof.

30. The polymer of claim 28, wherein the bioderived olefin is a bioderived cyclic olefin and the metathesis polymerization reaction is a ring opening metathesis polymerization reaction.

31. The polymer of claim 30, wherein the polymer is an AB alternating polymer.

32. The polymer of claim 28, wherein the product is from an acyclic diene metathesis polymerization reaction and wherein the bioderived olefin is an acyclic diene derived from a bioderived fatty acid.

33. The polymer of claim 28, wherein the bioderived glycerol is produced from a triacylglycerol selected from the group consisting of corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, tallow, beef tallow, butter, chicken fat, lard, dairy butterfat, shea butter, biodiesel, used frying oil, oil miscella, used cooking oil, yellow trap grease, hydrogenated oils, derivatives of these oils, fractions of these oils, conjugated derivatives of these oils, and mixtures of any thereof.

34. The polymer of claim 28, wherein the bioderived olefin is selected from the group consisting of monoacrylates, diacrylates, and allyl esters.

35. A polymer comprising:
a product of an acyclic diene metathesis polymerization reaction of a bioderived acyclic diene, wherein the bioderived acyclic diene is made from a bioderived fatty acid and the polymer is 100% biobased as determined by ASTM international Radioisotope Method D 6866.

36. The polymer of claim 35, wherein the polymer has a polydispersity index from 1 to 3.

37. The polymer of claim 35, wherein the polymer is further functionalized in a reaction selected from the group consisting of hydroformylation, hydroxylation, epoxidation, hydrogenation, and heat-bodied polymerization.

38. A method for producing a bioderived polymer, the method comprising:
reacting a compound selected from the group consisting of bioderived diols, bioderived amino alcohols, bioderived diamines, and combinations of any thereof with at least two equivalents of acrylic acid to yield a diacryl monomer product, wherein the acrylic acid is produced from bioderived glycerol; and
reacting the diacryl monomer product with a bioderived olefin in a metathesis polymerization reaction to form a bioderived polymer, wherein the bioderived polymer is 100% biobased as determined by ASTM Method International Radioisotope Method D 6866.

39. The method of claim 38, wherein the bioderived diol is selected from the group consisting of isosorbide, 2,5-bishydroxymethyltetrahydrofuran, 2,5-bishydroxymethylfuran, a diol produced from the hydrogenation of a hydroformylated fatty acid, a diol produced from the hydrogenation of an epoxidized fatty acid ester, a diol produced from the reduction of an α,ω-dicarboxylic acid, and mixtures thereof.

40. The method of claim 38, wherein the bioderived diamine is selected from the group consisting of bis-amino isosorbide, 2,5-bisaminomethyltetrahydrofuran, 2,5-bisaminomethylfuran, and mixtures thereof.

41. The method of claim 38, wherein the bioderived olefin is a cyclic olefin and the metathesis polymerization reaction is a ring opening metathesis polymerization reaction.

42. The method of claim 41, wherein the polymer is an AB alternating polymer.

43. The method of claim 41, wherein the cyclic olefin is produced from an anodic coupling of a monounsaturated long chain dicarboxylic acid derived from a bioderived fatty acid.

44. The method of claim 38, wherein the bioderived olefin is an acyclic diene derived from a bioderived fatty acid and wherein the metathesis polymerization reaction is an acyclic diene metathesis polymerization reaction.

45. The method of claim 38, wherein the bioderived glycerol is produced from a triacylglycerol selected from the group consisting of corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, tallow, beef tallow, butter, chicken fat, lard, dairy butterfat, shea butter, biodiesel, used frying oil, oil miscella, used cooking oil, yellow trap grease, hydrogenated oils, derivatives of these oils, fractions of these oils, conjugated derivatives of these oils, and mixtures of any thereof.

46. A polymer composition comprising:
a monomer unit having an electrophilic reactive group and a nucleophilic reactive group, wherein the electrophilic reactive group is selected from the group consisting of an aldehyde, an aldimine, an α,β-unsaturated carbonyl, and an α,β-unsaturated nitrile and the nucleophilic reactive group is selected from the group consisting of an α,β-unsaturated ester, α,β-unsaturated amide, α,β-unsaturated aldehyde, an α,β-unsaturated ketone, an α,β-unsaturated sulfone, an α,β-unsaturated sulfonate, α,β-unsaturated nitrile, and an α,β-unsaturated phosphate,
wherein the nucleophilic reactive group reacts with the electrophilic reactive group via a Baylis-Hillman type reaction to form a polymer.

47. An AB alternating condensation polymer comprising:
a first monomer unit comprising a first electrophilic reactive group and a second electrophilic reactive group, wherein the first electrophilic reactive group and the second electrophilic reactive group are each independently selected from the group consisting of an aldehyde, an aldimine, an α,β-unsaturated carbonyl, and an α,β-unsaturated nitrile; and
a second monomer unit comprising a first nucleophilic reactive group and a second nucleophilic reactive group, wherein the first nucleophilic reactive group and the second nucleophilic reactive group are each independently selected from the group consisting of an α,β-unsaturated ester, an α,β-unsaturated amide, an α,β-unsaturated aldehyde, an α,β-unsaturated ketone, an α,β-unsaturated sulfone, an α,β-unsaturated sulfonate, an α,β-unsaturated nitrile, and an α,β-unsaturated phosphate,
wherein the first monomer unit reacts with the second monomer unit via a Baylis-Hillman type reaction to form a polymer.
